(19) United States
(12) Patent Application Publication
(10) Pub. No.: US 2015/0218453 A1
(43) Pub. Date: Aug. 6, 2015

(54) LIQUID CRYSTAL CURED LAYER

(71) Applicant: SUMITOMO CHEMICAL COMPANY, LIMITED, Tokyo (JP)

(72) Inventors: Tadahiro KOBAYASHI, Osaka-shi (JP); Takahiro KOBAYASHI, Osaka-shi (JP); Tatsuaki KASAI, Osaka-shi (JP)

(73) Assignee: SUMITOMO CHEMICAL COMPANY, LIMITED, Tokyo (JP)

(21) Appl. No.: 14/610,934

(22) Filed: Jan. 30, 2015

(30) Foreign Application Priority Data
Jan. 31, 2014 (JP) 2014-017297

(51) Int. Cl. C09K 19/38; B32B 38/10; B32B 37/00; B32B 37/24; B32B 37/12

(52) U.S. Cl. CPC C09K 19/3823; B32B 37/24; B32B 37/12; B32B 37/025; B32B 38/10; B32B 2037/243; B32B 2037/1246; B32B 2457/202

(57) ABSTRACT

Provided is a liquid crystal cured layer wherein a transferring is easily performed, resulting in reducing the occurrence of defects and exhibiting excellent transparency. A liquid crystal cured layer formed from a polymerizable liquid crystal compound having an ethylenically unsaturated bond and an aromatic ring and satisfying a formula (Y). 0.95>P1/P2>0.60 (Y) [P1: P value for one of surfaces vertical to a thickness direction of the liquid crystal cured layer, P2: P value for the other of surfaces vertical to a thickness direction of the liquid crystal cured layer, P=I(1)/I(2), I(1): Peak intensity from in-plane deformation vibration of the ethylenically unsaturated bond measured by attenuated total reflection IR spectroscopy, and I(2): Peak intensity from stretching vibration of an unsaturated bond of the aromatic ring measured by attenuated total reflection IR spectroscopy]

### BACKGROUND OF THE INVENTION

1. Field of the Invention

The present invention relates to a liquid crystal cured layer and the like.

2. Description of the Related Art

A flat panel display device (FPD) is made of a member including an optical film such as a polarizing plate or a retardation plate. As such an optical film, known is an optical film including a crystal liquid cured layer formed from a polymerizable crystal liquid compound. JP-A-2010-537955 discloses an optical film including a liquid crystal cured layer which exhibits reverse wavelength dispersion property.

### SUMMARY OF THE INVENTION

In conventional liquid crystal cured layers, a transferring is not easily performed, and defects sometimes have occurred. Also, the transparency may not be sufficiently satisfactory.

The present invention includes the following aspects:

[1] A liquid crystal cured layer formed from a polymerizable liquid crystal compound having an ethylenically unsaturated bond and an aromatic ring, the layer satisfying a formula (Y),

0.95>P1/P2>0.60 (Y)

wherein P1 is a value of P taken in one of two surfaces of the liquid crystal cured layer perpendicular to the thickness direction of the layer,

P2 is a value of P taken in the other surfaces,

wherein P is defined by

P=I(1)/I(2)

wherein I(1) is the intensity of a peak derived from in-plane deformation vibration of the ethylenically unsaturated bond measured by attenuated total reflection IR spectroscopy, and

I(2) is the intensity of a peak derived from stretching vibration of an unsaturated bond of the aromatic ring measured by attenuated total reflection IR spectroscopy.

[2] The liquid crystal cured layer according to item [1], the layer having a thickness of 0.5 to 5 μm.

[3] The liquid crystal cured layer according to item [1] or [2], wherein the layer satisfies the formulas (1) and (2):

Re(450)/Re(550)≦1.00 (1)

1.00≦Re(650)/Re(550) (2)

wherein Re(450), Re(550), and Re(650) represent front retardation values at wavelengths of 450 nm, 550 nm and 650 nm, respectively.

[4] A method of producing a laminate comprising steps of forming the liquid crystal cured layer according to any one of 1 to 3 on a substrate, laminating the liquid crystal cured layer to a receiver through the pressure sensitive adhesive layer and removing the substrate.

[5] A display device including the liquid crystal cured layer according to any one of items [1] to [3].

In the liquid crystal cured layer of the present invention, a transferring is easily performed, reducing the occurrence of defects, and exhibiting excellent transparency.

### BRIEF DESCRIPTION OF THE DRAWINGS

FIG. 1 is a schematic view of a liquid crystal display device including a liquid crystal cured layer; and

FIG. 2 is a schematic view of an organic EL display device including a circularly polarizing plate having a liquid crystal cured layer.

### DETAILED DESCRIPTION OF THE PREFERRED EMBODIMENTS

### Liquid Crystal Cured Layer

The liquid crystal cured layer of the present invention is a liquid crystal cured layer formed from a polymerizable liquid crystal compound having an ethylenically unsaturated bond and an aromatic ring, and the layer satisfying a formula (Y),

0.95>P1/P2>0.60 (Y)

wherein, P1 is a value of P taken in one of surfaces perpendicular to a thickness direction of the layer,

P2 is a value of P taken in the other of surfaces perpendicular to a thickness direction of the liquid crystal cured layer,

wherein P is defined by

P=1(1)/1(2),

I(1) is the intensity of a peak from in-plane deformation vibration of the ethylenically unsaturated bond measured by attenuated total reflection IR spectroscopy, and

I(2) is the intensity of a peak from stretching vibration of an unsaturated bond of the aromatic ring measured by attenuated total reflection IR spectroscopy.

a value of P (hereinafter, sometimes referred to as P values) represent a ratio of peak intensities from in-plane deformation vibration of an ethylenically unsaturated bond to peak intensities from stretching vibration of an unsaturated bond of an aromatic ring, measured by attenuated total reflection IR spectroscopy. In curing a polymerizable liquid crystal compound, the unsaturated bond of an aromatic ring does not react, but the ethylenically unsaturated bond diminishes. Thus, the amount of the ethylenically unsaturated bond contained in a liquid crystal cured layer can be calculated by measuring P values for peak intensity of the unsaturated bond of an aromatic ring which does not react as relative standard.

When the ratio of P value for one of surfaces perpendicular to a thickness direction of the liquid crystal cured layer (P1) to P value for the other of surfaces perpendicular to a thickness direction of the liquid crystal cured layer (P2), (P1/P2), is higher than 0.6, a liquid crystal cured layer can be obtained wherein a transferring to a liquid crystal cured layer is easily performed, resulting in reducing the occurrence of defects and exhibiting excellent transparency. When the ratio (P1/P2) is smaller than 0.95, adhesive property between a pressure sensitive adhesive and P2 surface is improved, resulting in easy peeling of a substrate from a liquid crystal cured layer at a transferring.

Herein, unless otherwise specified, P values are calculated for layer surface of air interface side as P2 and for layer surface of substrate interface side as P1 as described below, respectively.

A liquid crystal cured layer is usually obtained by applying a composition containing a polymerizable liquid crystal compound (hereinafter, sometimes referred to as composition for forming liquid crystal cured layer) on a substrate or an orientation layer formed on a substrate, and polymerlizing the polymerizable liquid crystal compound.

The liquid crystal cured layer is usually a layer prepared by curing a polymerizable liquid crystal compound in oriented state and having a thickness of 5 μm or less, preferably in which the polymerizable liquid crystal compound is cured in horizontally or vertically oriented state to in-plane of substrate.

The liquid crystal cured layer preferably has a thickness of 0.5 to 5 μm, more preferably 1 to 3 μm. Thickness of the liquid crystal cured layer can be measured by a interferometer, a laser microscope or an antenna type thickness meter.

the liquid crystal cured layer in which a polymerizable liquid crystal compound is cured in horizontally oriented state to in-plane of substrate, prefers that a front retardation value to light at λ nm of wavelength, Re (λ), preferably satisfies the formulas (1) and (2), more preferably the formulas (1), (2) and (3):

Re(450)/Re(550)≦1.00 (1)

1.00≦Re(650)/Re(550) (2)

wherein Re(450), Re(550), and Re(650) represent front retardation values at 450 nm, 550 nm and 650 nm of wavelength, respectively, and

100<Re(550)<150 (3).

Front retardation value of a liquid crystal cured layer can be adjusted by controlling a thickness of the liquid crystal cured layer. Front retardation value is determined by formula (50) and therefore, Δn(λ) and layer thickness d are only adjusted in order to obtain a desired front retardation value (Re(λ)):

Re(λ)=d×Δn(λ) (50)

wherein Re (λ) represents front retardation value at λ nm of wavelength, d represents layer thickness, and Δn(λ) represents birefringence at λ nm of wavelength.

The birefringence Δn(λ) is obtained by measuring front retardation value and dividing the front retardation value by thickness of a liquid crystal cured layer. Specific methods for measuring it are described in Examples, that is, substantial property of a liquid crystal cured layer can be measured by measuring a layer which is formed on a substrate having no in-plane retardation such as a glass substrate.

A polymerizable liquid crystal compound is a compound having a polymerizable group and liquid crystal property. The polymerizable group means a group associated with polymerization reaction and preferably a photopolymerizable group. Herein, the photopolymerizable group means a group which may be associated with polymerization reaction by active radicals and acids generated from a photopolymerization initiator.

The polymerizable liquid crystal compound of the present invention has an ethylenically unsaturated bond as a polymerizable group and also has an aromatic ring.

Examples of polymerizable groups include a vinyl group, a vinyloxy group, a 1-chlorovinyl group, an isopropenyl group, a 4-vinylphenyl group, an acryloyloxy group, a methacryloyloxy group, preferably an acryloyloxy group, a methacryloyloxy group and a vinyloxy group, more preferably an acryloyloxy group. The liquid crystal property can be either a thermotropic liquid crystal or a lyotropic liquid crystal, and can be either a nematic liquid crystal or a smectic liquid crystal in the thermotropic liquid crystal. Preferred is a nematic liquid crystal in the thermotropic liquid crystal property in view of easy producing. Examples of aromatic rings include a benzene ring and a naphthalene ring.

When the liquid crystal cured layer satisfies the formulas (1) and (2), the polymerizable liquid crystal compound is preferably a compound represented by a formula (A) (hereinafter, sometimes referred to as compound (A)). The polymerizable liquid crystal compound can be used alone or in combination.

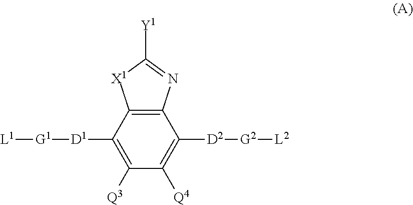

In the formula, X¹ is an oxygen atom, a sulfur atom or a —NR¹—. R¹ is a hydrogen atom or an alkyl group having 1 to 4 carbon atoms.

Y¹ is a monovalent aromatic hydrocorbon group having 6 to 12 carbon atoms which may have a substituent or a monovalent aromatic heterocyclic group having 3 to 12 carbon atoms which may have a substituent.

Q³ and Q⁴ are each independently a hydrogen atom, a monovalent aliphatic hydrocarbon group having 1 to 20 carbon atoms which may have a substituent, a monovalent alicyclic hydrocarbon group having 3 to 20 carbon atoms, a monovalent aromatic hydrocarbon group having 6 to 20 carbon atoms which may have a substituent, a halogen atom, a cyano group, a nitro group, —NR²R³ or —SR², or Q³ and Q⁴, together with the carbon atom to which they are bonded, form an aromatic ring or an aromatic heterocyclic ring. R² and R³ are each independently a hydrogen atom or an alkyl group having 1 to 6 carbon atoms.

D¹ and D² are each independently a single bond, —C(═O)—O—, —C(═S)—O—, —CR⁴R⁵—, —CR⁴R⁵—CR⁶R⁷—O—CR—, —CR⁴R⁵—O—CR⁶R⁷—CO—O—CR⁴R⁵—, —O—CO—CR⁴R⁵—, —CR⁴R⁵—O—CO—CR⁶R⁷—, —CR⁴R⁵—CO—O—CR⁶R⁷—, —NR⁴—CR⁵R⁶— or —CO—NR⁴—.

R⁴, R⁵, R⁶ and R⁷ are each independently a hydrogen atom, fluorine atom or an alkyl group having 1 to 4 carbon atoms.

G¹ and G² are each independently a bivalent alicyclic hydrocarbon group having 5 to 8 carbon atoms wherein a methylene group constituting the alicyclic hydrocarbon group may be substituted with an oxygen atom, a sulfur atom or —NH—, and a methine group constituting the alicyclic hydrocarbon group may be substituted with a tertiary nitrogen atom.

L¹ and L² are each independently a monovalent organic group, and at least one of L¹ and L² has a polymerizable group.

in the compound (A) is preferably a group represented by a formula (A1), and L² is preferably a group represented by a formula (A2):

P¹-F¹-(B¹-A¹)ₖ-E¹- (A1)

P²-F²-(B²-A²)ₗ-E²- (A2)

wherein B¹, B², E¹ and E² are each independently —CR⁴R⁵—, —CH₂—CH₂—, —O—, —S—, —CO—O—, —O—CO—O—, —CS—O—, —O—CS—O—, —CO—NR¹—, —O—CH₂—, —S—CH₂— or a single bond;

A¹ and A² are each independently a bivalent alicyclic hydrocarbon group having 5 to 8 carbon atoms or a bivalent aromatic hydrocarbon group having 6 to 18 carbon atoms, wherein a methylene group constituting the alicyclic hydrocarbon group may be substituted with an oxygen atom, a sulfur atom or —NH—, and a methine group constituting the alicyclic hydrocarbon group may be substituted with a tertiary nitrogen atom;

k and l are each independently an integer of 0 to 3;

F¹ and F² are each independently a bivalent aliphatic hydrocarbon group having 1 to 12 carbon atoms;

P¹ is a polymerizable group;

P² is a hydrogen atom or a polymerizable group; and

R⁴ and R⁵ are each independently a hydrogen atom, fluorine atom or an alkyl group having 1 to 4 carbon atoms.

Preferred examples of compound (A) include a polymerizable liquid crystal compound disclosed in JP-A-2011-207765.

Examples of polymerizable liquid crystal compounds different from compound (A) include a compound containing a group represented by a formula (X) (hereinafter, sometimes referred to as “compound (X)”):

P¹¹-B¹¹-E¹¹-B¹²-A¹¹-B¹³- (X)

wherein P¹¹ is a polymerizable group;

A¹¹ is a bivalent alicyclic hydrocarbon group or a bivalent aromatic hydrocarbon group provided that any hydrogen atom contained in the bivalent alicyclic hydrocarbon group or bivalent aromatic hydrocarbon group may substituted with a halogen atom, an alkyl group having 1 to 6 carbon atoms, an alkoxy group having 1 to 6 carbon atoms, a cyano group or a nitro group provided that any hydrogen atom contained in the alkyl group having 1 to 6 carbon atoms or the alkoxy group having 1 to 6 carbon atoms may substituted with a fluorine atom;

B¹¹ is —O—, —S—, —CO—O—, —O—CO—, —O—CO—O—, —CO—NR¹⁶—, —NR¹⁶—CO—, —CO—, —CS— or single bond wherein R¹⁶s each represent a hydrogen atom or an alkyl group having 1 to 6 carbon atoms;

B¹² and B¹³ are each independently —C≡C—, —CH═CH—, —CH₂—CH₂—, —O—, —S—, —C(═O)—, —C(═O)—O—, —O—C(═O)—, —O—C(═O)—O—, —CH═N—, —N═CH—, —N═N—, —C(═O)—NR¹⁶—, —NR¹⁶—C(═O)—, —OCH₂—, —OCF₂—, —CH₂O—, —CF₂O—, —CH═CH—C(═O)—O—, —O—C(═O)—CH═CH— or single bond; and

E¹¹ is an alkanediyl group having 1 to 12 carbon atoms provided that any hydrogen atom contained in the alkanediyl group may be substituted with an alkoxy group having 1 to 5 carbon atoms, provided that any hydrogen atom contained in the alkoxy group may be substituted with a halogen atom, and provided that any —CH₂— that constitutes the alkanediyl group may be substituted with —O— or —CO—.

Examples of the polymerizable liquid crystal compound include the compounds having a polymerizable group out of compounds selected from those described in “3.8.6 Network (Completely Crosslinked Type)” and “6.5.1 Liquid Crystal Material, b. Polymerizable Nematic Liquid Crystal Material” in “Liquid Crystal Handbook” (edited by Liquid Crystal Handbook Editorial Committee, and published by Maruzen Publishing Co., Ltd. on Oct. 30, 2000); and polymerizable liquid crystal compounds described in JP-A-2010-31223, JP-A-2010-270108, JP-A-2011-6360, and JP-A-2011-207765.

The content of polymerizable liquid crystal compound is usually 70 to 99.5 parts by mass, preferably 80 to 99 parts by mass, more preferably 80 to 94 parts by mass, still more preferably 80 to 90 parts by mass relative to 100 parts by mass of the solid content of composition for forming a liquid crystal cured layer. When the content is within the range as described above, the orientation property is likely to be increased. Herein, the solid content means total amount of components excluding a solvent from composition for forming liquid crystal cured layer.

The composition for forming liquid crystal cured layer can contain a solvent, a polymerization initiator, a sensitizer, a polymerization inhibitor and a leveling agent.

### <Solvents>

The solvent preferably can solve a polymerizable liquid crystal compound and is inert to the polymerization reaction of polymerizable liquid crystal compound.

Examples of the solvent include alcohol solvents such as methanol, ethanol, ethylene glycol, isopropyl alcohol, propylene glycol, ethylene glycol methyl ether, ethylene glycol butyl ether and propylene glycol monomethyl ether; ester solvents such as ethyl acetate, butyl acetate, ethylene glycol methyl ether acetate, γ-butyrolactone or propylene glycol methyl ether acetate and ethyl lactate; ketone solvents such as acetone, methyl ethyl ketone, cyclopentanone, cyclohexanone, 2-heptanone and methyl isobutyl ketone; aliphatic hydrocarbon solvents such as pentane, hexane and heptane; aromatic hydrocarbon solvents such as toluene and xylene; nitrile solvents such as acetonitrile; ether solvents such as tetrahydrofuran and dimethoxyethane; chlorine containing solvents such as chloroform and chlorobenzene or the like. Such solvents can be used alone or in combination.

The content of solvent is preferably 50 to 98 parts by mass relative to 100 parts by mass of composition for forming liquid crystal cured layer. The solid content of composition for forming liquid crystal cured layer is preferably 2 to 50 parts by mass relative to 100 parts by mass of composition for forming liquid crystal cured layer. When the solid content is 2 parts by mass or less, the viscosity of composition for forming liquid crystal cured layer becomes lower and the thickness of liquid crystal cured layer becomes substantially even, so that the surface irregularity of liquid crystal cured layer is less likely to be caused. The solid content can be determined in view of the thickness of liquid crystal cured layer to be produced.

### <Polymerization Initiator>

The polymerization initiator is a compound which can initiate polymerization reaction of polymerizable liquid crystal compound or the like. Preferred is a photopolymerization initiator which generates active radicals by light as a polymerization initiator.

Examples of polymerization initiators include benzoin compound, benzophenone compound, alkylphenone compound, acylphosphine oxide compound, triazine compound, iodonium salt, sulfonium salt and the like.

Examples of benzoin compound include benzoin, benzoin methyl ether, benzoin ethyl ether, benzoin isopropyl ether, benzoin isobutyl ether and the like.

Examples of benzophenone compound include benzophenone, o-benzoylbenzoic acid methyl ester, 4-phenylbenzophenone, 4-benzoyl-4′-methyldiphenylsulfide, 3,3′,4,4′-tetra(tert-butylperoxycarbonyl)benzophenone, 2,4,6-trimethylbenzophenone and the like.

Examples of alkylphenone compound include diethoxyacetophenone, oligomer of 2-methyl-2-morpholino-1-(4-methylthiophenyl)propane-1-one, 2-benzyl-2-dimethylamino-1-(4-morpholinophenyl)butane-1-one, 2-hydroxy-2-methyl-1-phenylpropane-1-one, 1,2-diphenyl-2,2-dimethoxyethane-1-one, 2-hydroxy-2-methyl-1-[4-(2-hydroxyethoxyl)phenyl]propane-1-one, 1-hydroxycyclohexyl phenyl ketone, 2-hydroxy-2-methyl-1-[4-(1-methyl vinyl)phenyl]propane-1-one and the like.

Examples of acylphosphine oxide compound include 2,4,6-trimethylbenzoyldiphenylphosphine oxide, bis(2,4,6-trimethylbenzoyl)phenylphosphineoxide and the like.

Examples of triazine compound include 2,4-bis(trichloromethyl)-6-(4-methoxyphenyl)-1,3,5-triazine, 2,4-bis(trichloromethyl)-6-(4-methoxynaphthyl)-1,3,5-triazine, 2,4-bis(trichloromethyl)-6-(4-methoxystyryl)-1,3,5-triazine, 2,4-bis(trichloromethyl)-6-[2-(5-methylfuran-2-yl)ethenyl]-1,3,5-triazine, 2,4-bis(trichloromethyl)-6-[2-(furan-2-yl)ethenyl]-1,3,5-triazine, 2,4-bis(trichloromethyl)-6-[2-(4-diethylamino-2-methylphenyl)ethenyl]-1,3,5-triazine, 2,4-bis(trichloromethyl)-6-[2-(3,4-dimethoxyphenyl)ethenyl]-1,3,5-triazine and the like.

Examples of polymerization initiators available commercially include “Irgacure (registered trademark) 907”, “Irgacure184”, “Irgacure651”, “Irgacure819”, “Irgacure250”, “Irgacure369” (Ciba Japan K.K.); “Seikuol (registered trademark) BZ”, “Seikuol Z”, “Seikuol BEE” (Seiko Chemical Co., Ltd.); “Kayacure (registered trademark) BP100” (Nippon Kayaku Co., Ltd.); “Kayacure UVI-6992” (from Dow Chemical Company); “Adekaoptomer (registered trademark) SP-152”, “Adekaoptomer SP-170” (ADEKA CORPORATION); “TAZ-A”, “TAZ-PP” (DKSH Japan K.K.); “TAZ-104” (Sanwa Chemical Co., Ltd.) and the like.

The content of polymerization initiator is usually 0.1 to 30 parts by mass, preferably 0.5 to 10 parts by mass, more preferably 0.5 to 8 parts by mass relative to 100 parts by mass of polymerizable liquid crystal compound. The content of initiator is preferably within the range described above, since the orientation of the polymerizable liquid crystal compound is not disturbed.

### <Sensitizer>

The polymerization reaction of polymerizable liquid crystal compound can be further facilitated by a sensitizer.

Photosensitizer is preferred as a sensitizer. Examples of sensitizers include xanthone compounds such as xanthone and tioxanthone (2,4-diethylthioxanthone, 2-isopropylthioxanthone and the like); anthracene compounds such as anthracene and alkoxy group-containing anthracene (dibutoxyanthracene, etc.); phenothiazine, rubrene and the like.

The content of sensitizer is preferably 0.1 to 30 parts by mass, more preferably 0.5 to 10 parts by mass, still more preferably 0.5 to 8 parts by mass relative to 100 parts by mass of polymerizable liquid crystal compound.

### <Polymerization Inhibitor>

The progress of the polymerization reaction of a polymerizable liquid crystal compound can be controlled by a polymerization inhibitor.

Examples of polymerization inhibitors include radical scavengers such as a phenolic compound, a sulfuric compound, a phosphorus compound and an amine compound.

Examples of phenolic compounds include a 2,6-di-tert-butyl-4-methylphenol, a 2,6-di-tert-butyl -4-ethylphenol, butylhydroxyanisole, hydroquinone, alkoxy group-containing hydroquinone, alkoxy group-containing catechol (e.g. butylcatechol, etc.), pyrogallol and the like. Commercially available products can be used and examples thereof include Sumilizer (registered trademark) BHT (2,6-di-t-butyl-4-methylphenol), Sumilizer GM (2-tert-butyl-6-(3-tert-butyl-2-hydroxy-5-methylbenzyl)-4-m ethylphenyl acrylate), Sumilizer GS(F) (2-[1-(2-hydroxy-3,5-di-tert-pentylphenyl)ethyl]-4,6-di-ter t-pentylphenyl acrylate), Sumilizer GA-80 (3,9-bis[2-[3-(3-tert-butyl-4-hydroxy-5-methylphenyl)propionyloxy]-1,1-dimethylethyl]-2,4,8,10-tetraoxaspiro[5•5]undecane) (all manufactured by Sumitomo Chemical Co., Ltd.) and the like.

Examples of sulfuric compounds include dialkyl thiodipropionate such as dilauryl thiodipropionate, dimyristyl thiodipropionate, distearyl thiodipropionate; commercially available products such as Sumilizer TPL-R (dilauryl-3,3′-thiodipropionate), a Sumilizer TPM (dimyristyl-3,3′-thiodipropionate) (all manufactured by Sumitomo Chemical Co., Ltd.) and the like.

Examples of phosphorus compounds include trioctyl phosphite, trilauryl phosphite, tridecylphosphite, (octyl)diphenyl phosphite; commercially available products such as Sumilizer GP (6-[3-(3-tert-butyl-4-hydroxy-5-methylphenyl)propoxy]-2,4,8,10-tetra-tert-butyl-dibenzo[d,f][1,3,2]dioxaphosphepin) (manufactured by Sumitomo Chemical Co., Ltd.) and the like.

Phenolic compound is preferred as a polymerization inhibitor in that the liquid crystal cured layer is not much colored.

The content of polymerization inhibitor is preferably 0.1 to 30 parts by mass, more preferably 0.5 to 10 parts by mass, still more preferably 0.5 to 8 parts by mass relative to 100 parts by mass of polymerizable liquid crystal compound. When the inhibitor is included within the range described above, polymerizarion can be performed without disturbing the orientation of the polymerizable liquid crystal compound. The polymerization inhibitor can be used alone or in combination.

### <Leveling Agents>

A leveling agent is an agent which has functions to control fluidity of composition for forming liquid crystal cured layer and to further smooth the layer obtained by applying composition for forming liquid crystal cured layer and examples thereof include a surfactant. Preferred examples of leveling agents include a leveling agent containing a polyacrylate compound as a main component and a leveling agent containing a fluorine atom-containing compound as a main component.

Examples of leveling agents containing a polyacrylate compound as a main component include “BYK-350”, “BYK-352”, “BYK-353”, “BYK-354”, “BYK-355”, “BYK-358N”, “BYK-361N”, “BYK-380”, “BYK-381”, and “BYK-392” [BYK Chemie] and the like.

Examples of leveling agents containing a fluorine atom-containing compound as a main component include “Megafac (registered trademark) R-08”, “Megafac R-30”, “Megafac R-90”, “Megafac F-410”, “Megafac F-411”, “Megafac F-443”, “Megafac F-445”, “Megafac F-470”, “Megafac F-471”, “Megafac F-477”, “Megafac F-479”, “Megafac F-482” and “Megafac F-483” [DIC Corporation]; “Surflon (registered trademark) S-381”, “Surflon S-382”, “Surflon S-383”, “Surflon S-393”, “Surflon SC-101”, “Surflon SC-105”, “KH-40” and “SA-100”[AGC Seimi Chemical Co., Ltd.]; “E1830”, “E5844” [Daikin Fine Chemical Laboratory, Ltd.]; “EFtop EF301”, “EFtop EF303”, “EFtop EF351” and “EFtop EF352” [Mitsubishi Materials Electronic Chemicals Co., Ltd.] and the like.

The content of leveling agent is preferably 0.01 to 5 parts by mass, more preferably 0.1 to 3 parts by mass relative to 100 parts by mass of the polymerizable liquid crystal compound. The content falls preferably within the range described above, since the polymerizable liquid crystal compound is easily oriented horizontally, and the obtained liquid crystal cured layer is likely to be smoother. The composition for forming liquid crystal cured layer can contain two or more kind of leveling agents.

### <Substrate>

Examples of substrates include a glass substrate and a plastic substrate, preferably a plastic substrate. Examples of plastics constituting plastic substrates include polyolefin such as polyethylene, polypropylene, norbornene-based polymer; cyclic olefin resin; polyvinyl alcohol; polyethylene terephthalate; polymethacrylic acid ester; polyacrylic acid ester; cellulose ester such as triacetylcellulose, diacetylcellulose and cellulose acetate propionate; polyethylenenaphthalate; polycarbonate; polysulfone; polyethersulfon; polyether ketone; polyphenylenesulfide; polyphenyleneoxide and the like. Preferred are cellulose ester, cyclic olefin resin, polycarbonate, polyethylene terephthalate or polymethacrylic acid ester.

Cellulose ester in which at least one moiety of hydroxyl group of cellulose is esterified, can be easily available from the market. Cellulose ester substrate can be also easily available from the market. Examples of the commercially available cellulose ester substrate include “Fuji TAC film” (Fujifilm Corporation); “KC8UX2M”, “KC8UY”, “KC4UY” (Konica Minolta Opto Products Co., Ltd.) and the like.

Cyclic olefin resin is a composed of a polymer or a copolymer of cyclic olefin such as norbornene and polycyclic norbornene monomer (cyclic olefin resin), and the cyclic olefin resin can partially contain a ring-opening moiety. The cyclic olefin resin containing a ring-opening moiety can be hydrogenated. Furthermore, the cyclic olefin resin can be a copolymer of cyclic olefin with acyclic olefin or vinyl aromatic compound (styrene etc.) in that the transparency is not remarkably impaired and hygroscopicity is not remarkably increased. The cyclic olefin resin may have a structure such that a polar group is introduced in the molecule.

When cyclic olefin resin is a copolymer of cyclic olefin with acyclic olefin or an aromatic compound having a vinyl group, the content of structure unit derived from the cyclic olefin is usually 50 mol % or less, preferably 15 to 50 mol % based on total structure units of the copolymer. Examples of acyclic olefin include ethylene and propylene, and examples of aromatic compounds having a vinyl group include styrene, α-methylstyrene and alkyl substituted styrene. When cyclic olefin resin is a ternary copolymer of cyclic olefin, acyclic olefin and an aromatic compound having a vinyl group, the content of structural unit derived from acyclic olefin is usually 5 to 80 mol % based on total structure units of the copolymer, and the content of structural unit derived from an aromatic compound having a vinyl group is usually 5 to 80 mol % based on total structure units of the copolymer. Such ternary copolymers have advantages that the amount of expensive cyclic olefin can be relatively reduced in the production.

Examples of cyclic olefin resin available commercially include “Topas” (registered trademark) [Ticona, Germany], “ARTON” (registered trademark) [JSR Corporation], “ZEONOR” (registered trademark) [ZEON CORPORATION], “ZEONEX” (registered trademark) [ZEON CORPORATION] and “APEL” (registered trademark) [Mitsui Chemicals, Inc.]. Such a cyclic olefin resin can be subjected to film formation by known means such as solvent casting and melt extrusion to produce a substrate. The cyclic olefin resin substrate available commercially can be also used. Examples of cyclic olefin resin substrate available commercially include “Esushina” (registered trademark) [SEKISUI CHEMICAL CO., LTD.], “SCA40” (registered trademark)[SEKISUI CHEMICAL CO., LTD.], “ZeonorFilm” (registered trademark) [ZEON CORPORATION] and “Artonfilm” (registered trademark) [JSR Corporation].

The substrate is preferably thinner in that it has weight enabling practical handling, however, as the substrate is too thinner, it is likely to be decreased in strength and poor in processability. The substrate has usually a thickness of 5 to 300 μm, preferably 20 to 200 μm.

### <Orientation Layer>

An orientation layer is a layer which is composed of a polymer compound and has 500 nm or less of thickness, the layer having orientation regulating force for orienting a polymerizable liquid crystal compound into a desired direction.

The orientation layer facilitates liquid crystal-orientation of a polymerizable liquid crystal compound. The liquid crystal-orientation state such as horizontal orientation, vertical orientation, hybrid orientation, or oblique orientation varies depending on properties of an orientation layer and polymerizable liquid crystal compound, combination thereof can be arbitrarily selected. When the orientation layer is made of a material expressing horizontal orientation as orientation regulating force, the polymerizable liquid crystal compound can form horizontal or hybrid orientation, and when the orientation layer is made of a material expressing vertical orientation as orientation regulating force, the polymerizable liquid crystal compound can form vertical orientation or oblique orientation. Representation of horizontal, vertical, etc. indicates long axis direction of the oriented polymerizable liquid crystal compound based on a surface of the liquid crystal cured layer. The vertical orientation means that the oriented polymerizable liquid crystal compound has a long axis vertical to a surface of the liquid crystal cured layer. Herein, term “vertical” means 90°±20° to a surface of the liquid crystal cured layer.

The orientation regulating force can be arbitrarily controlled depending on surface states and rubbing conditions when the orientation layer is formed from an orienting polymer, and can be arbitrarily controlled depending on polarized radiation condition when the orientation layer is formed from an optically orienting polymer. The liquid crystal orientation can be also controlled by selecting physical properties of the polymerizable liquid crystal compound such as surface tension and liquid crystal properties.

When the liquid crystal cured layer satisfies the formula (4), the liquid crystal-orientation of polymerizable liquid crystal compound forming the liquid crystal cured layer is preferably vertical orientation. In order to vertically orientate polymerizable liquid crystal compound, the orientation layer having nonpolar substituent composed of a silicon atom, a fluorine atom, etc. is preferably used, and as described in Japanese Patent Nos. 4605016, 4985906 and 4502119 and WO2008/117760, materials which are generally used as a liquid crystal orientation layer of vertical oriented liquid crystal display element can be used as the orientation layer.

As an orientation layer formed between a substrate and a liquid crystal cured layer, preferred is an orientation layer which is insoluble in a solvent used in forming a liquid crystal cured layer on an orientation layer, and which has a heat resistance when the layer is heated to remove the solvent and orientate liquid crystal. Examples of orientation layers include an orientation layer containing an orienting polymer, a photo-orientation layer and a groove orientation layer.

The thickness of orientation layer is usually 10 to 500 nm, preferably 10 to 200 nm.

### <Orientation Layer Containing of Orienting Polymer>

Examples of orienting polymers include polyamides and gelatins which have amide bonds in themolecule, polyimides which have imide bonds in the molecule, polyamic acids which are a hydrolyzate of a polyimide, polyvinyl alcohols, alkyl modified polyvinyl alcohols, polyacrylamides, polyoxazoles, polyethyleneimines, polystyrene, polyvinylpyrrolidones, polyacrylates and polyacrylic esters, preferably polyvinyl alcohols. These orienting polymers can be used alone or in combination.

The orientation layer containing the orienting polymer can be usually obtained by applying an orienting polymer composition in which the orienting polymer is dissolved in a solvent (hereinafter, sometimes referred to as orienting polymer composition) to the above-mentioned substrate, and then removing the solvent to form an applied layer, or applying an orienting polymer composition onto a substrate, removing the solvent to form the applied layer and then rubbing the applied layer (rubbing method).

Examples of solvents include water; alcohol solvents such as methanol, ethanol, ethylene glycol, isopropyl alcohol, propylene glycol, methyl cellosolve, butyl cellosolve and propyleneglycol monomethyl ether; ester solvents such as ethyl acetate, butyl acetate, ethylene glycol methyl ether acetate, γ-butyrolactone, propylene glycol methyl ether acetate and ethyl lactate; ketone solvents such as acetone, methyl ethyl ketone, cyclopentanone, cyclohexanone, methyl amyl ketone and methyl isobutyl ketone; aliphatic hydrocarbon solvents such as pentane, hexane and heptane; aromatic hydrocarbon solvents such as toluene and xylene, nitrile solvents such as acetonitrile; ether solvents such as tetrahydrofuran and dimethoxyethane; chlorine-substituted hydrocarbon solvents such as chloroform and chlorobenzene; and the like. These solvents can be used alone or in combination.

The orienting polymer in the orienting polymer composition preferably has a concentration which can be within the range that the orienting polymer material can be completely dissolved in the solvent. The concentration is preferably from 0.1 to 20%, more preferably 0.1 to 10% in terms of a solid content based on the solution.

Examples of commercially available orienting polymer composition include Sunever (registered trademark, manufactured by NISSAN CHEMICAL INDUSTRIES, LTD.) or Optmer (registered trademark, manufactured by JSR Corporation).

Examples of methods for applying the orienting polymer compositions onto the substrate include known methods such as spin coating, extrusion, gravure coating, die coating, bar-coating, applicator method and other coating methods, and flexographic and other printing methods.

A dried coating of the orienting polymer is formed by removing the solvent contained in the orienting polymer composition. Examples of a method for removing solvents include natural drying, ventilation drying, heat drying, and reduced-pressure drying.

Examples of a rubbing method include a method which includes contacting a rubbing roll rotating to which the rubbing cloth is wound, with a layer of the orienting polymer which is formed onto a surface of the substrate by applying and annealing the orienting polymer composition to the substrate.

### <Photo-Orientation Layer>

A photo-orientation layer is generally obtained by applying onto a substrate a composition containing a polymer or monomer having an optically reactive group and a solvent (hereinafter, sometimes referred to as “composition for forming a photo-orientation layer”), and irradiating with polarized light (preferably polarized UV light). A photo-orientation layer is preferred in that a direction of orientation regulating force can be arbitrarily controlled by selecting polarized directions of polarized light radiated.

An optically reactive group refers to a group providing liquid crystal-orientation ability by irradiating with light. In particular, it is a group generating photoreaction as a source of liquid crystal-orientation ability, including orientation induced by molecules due to irradiation with light or reactions with isomerization, dimerization, photocrosslinking, or photodegradation. Examples of optically reactive groups which can generate such reactions preferably include a group having an unsaturated bond, particularly double bond, particularly preferably a group having at least one selected from the group consisting of carbon-carbon double bond (C═C bond), carbon-nitrogen double bond (C═N bond), nitrogen-nitrogen double bond (N═N bond), and carbon-oxygen double bond (C═O bond).

Examples of optically reactive group having a C═C bond include a vinyl group, a polyene group, a stilbene group, a stilbazole group, a stilbazolium group, a chalcone group and a cinnamoyl group. Examples of optically reactive group having a C═N bond include a group having a structure such as aromatic schiff base and aromatic hydrazone. Examples of optically reactive group having a N═N bond include an azobenzene group, an azonaphthalene group, an aromatic heterocyclic azo group, a bisazo group and a formazan group, and a group having an azoxybenzene as a basic structure. Examples of optically reactive group having a C═O bond include a benzophenone group, a coumarin group, an anthraquinone group and a maleimide group. These groups can have a substituent such as an alkyl group, an alkoxy group, an aryl group, an allyloxy group, a cyano group, an alkoxycarbonyl group, a hydroxyl group, a sulfonate group and an alkyl halide group.

Preferred is a group associated with photodimerization or photocrosslinking reaction as an optically reactive group due to excellent orientation property. Among them, preferred is an optically reactive group associated with photodimerization, and preferred are a cinnamoyl group and a chalcone group since the radiated polarized light amount which is required for optical orientation is relatively low and optical orientation layers excellent in thermal and temporal stabilities are easily obtained. As a polymer having an optically reactive group, particularly preferred is a polymer having a cinnamoyl group such that the polymer side chain has a structure of cinnamic acid at end parts.

Preferred is a solvent which dissolves a polymer or monomer having an optically reactive group as a solvent of the composition for forming the photo-orientation layer. The examples of the solvent include solvents mentioned as solvents of the orienting polymer composition.

The content of the polymer or monomer having optically reactive group is preferably 0.2 mass % or more, particularly preferably 0.3 to 10 mass % based on a composition for forming photo-orientation layer. The composition for forming a photo-orientation layer can contain polymer materials such as polyvinyl alcohol and polyimide and a photosensitizer as long as properties of photo-orientation layer are not significantly impaired.

The method for applying the composition for forming a photo-orientation layer onto the substrate may be the same method as used for applying the orienting polymer composition onto the substrate. The method for removing the solvent from the applied composition for forming a photo-orientation layer may be the same method as used for removing the solvent from the orienting polymer composition.

For the radiation of the polarized light, any one of the following is usable: a manner of radiating the polarized light onto a workpiece obtained by removing the solvent from the composition for forming an optically orientation layer applied on the substrate so that the light is directly radiated onto the applied composition; or a manner of radiating the polarized light onto the workpiece from the substrate side thereof to penetrate the substrate, thereby being radiated to the applied composition. Rays of the polarized light are particularly preferably substantially parallel rays. The wavelength of the polarized light to be radiated is preferably in the range of wavelengths the optical energy of which can be absorbed by the optically reactive group of the polymer or monomer having the optically reactive group. Specifically, the wavelength is in particular preferably from 250 to 400 nm, which correspond to UV rays (ultraviolet rays). Examples of a light source for radiating the polarized light include a xenon lamp, a high-pressure mercury lamp, a super-high-pressure mercury lamp, a metal halide lamp, and ultraviolet lasers such as KrF and ArF lasers. Of these examples, preferred are high-pressure mercury, super-high-pressure mercury, and metal halide lamps since the lamps emit an ultraviolet ray of 313 nm wavelength with a high emission intensity. By radiating light from the light source through an appropriate polarizer onto the applied composition for forming a photo-orientation layer, polarized rays can be radiated thereto. Examples of the polarizer include a polarizing filter, polarizing prisms such as Glan-Thomson and Glan-Taylor prisms, and a wire-grid-type polarizer.

It is noted that in rubbing or polarized irradiation, a plurality of regions (patterns) with various liquid crystal-orientation directions can be also formed by means of masking at the time of rubbing or the radiation of the polarized light.

### <Groove Orientation Layer>

A groove orientation layer is a layer having irregularity patterns or a plurality of grooves in the layer surface. When liquid crystal compounds are put on a layer having grooves in the form of straight lines arranged at regular intervals, the liquid crystal molecules are oriented in a direction along the grooves.

Examples of the method for producing the groove orientation layer include a method of exposing a surface of a photosensitive polyimide layer through an exposure mask having slits in a pattern form to light, and then subjecting to developing and rinsing treatments to form an irregularity pattern; a method of forming an uncured UV curable resin layer on an original plate having grooves in a surface, shifting the resin layer onto a substrate, and then curing the resin layer; and a method of pressing an original roll having grooves onto an uncured UV curable resin layer formed on a substrate to form irregularities in the resin layer, and then curing the resin layer. Specific examples include methods disclosed in JP-A-6-34976, JP-A-2011-242743, and others.

Among the above-mentioned methods, preferred is the method of pressing an original roll having grooves onto an uncured UV curable resin layer formed on a substrate to form irregularities in the resin layer, and then curing the resin layer. The original roll is preferably made of stainless (SUS) steel in view of durability.

Examples of UV curable resins include a resin made from a monofunctional acrylate, a polyfunctional acrylate, or a mixture thereof.

Monofunctional acrylate is a compound having one selected from the group consisting of an acryloyloxy group (CH₂═CH—COO—) and a methacryloyloxy group (CH₂═C(CH₃)—COO —) (hereinafter sometimes referred to as a (meth)acryloyloxy group). The term, “(meth)acrylate” means acrylate or methacrylate.

Examples of monofunctional acrylate having one (meth)acryloyloxy group include alkyl(meth)acrylate having 4 to 16 carbon atoms, β-carboxyalkyl(meth)acrylate having 2 to 14 carbon atoms, alkylated phenyl(meth)acrylate having 2 to 14 carbon atoms, methoxypolyethylene glycol(meth)acrylate, phenoxypolyethylene glycol(meth)acrylate, and isobornyl(meth)acrylate.

Polyfunctional acrylate is a compound having two or more (meth)acryloyloxy groups, and is preferably a compound having 2 to 6 (meth)acryloyloxy groups.

Examples of polyfunctional acrylate having two (meth)acryloyloxy groups include 1,3-butanediol di(meth)acrylate; 1,3-butanediol(meth)acrylate; 1,6-hexanediol di(meth)acrylate; ethylene glycol di(meth)acrylate; diethylene glycol di(meth)acrylate; neopentylglycol di(meth)acrylate; triethylene glycol di(meth)acrylate; tetraethylene glycol di(meth)acrylate; polyethylene glycol diacrylate; bis(acryloyloxyethyl) ether of bisphenol A; ethoxylated bisphenol A di(meth)acrylate; propoxylated neopentylglycol di(meth)acrylate; ethoxylated neopentyl glycol di(meth)acrylate; and 3-methylpentanediol di(meth)acrylate.

Examples of polyfunctional acrylate having 3 to 6 (meth)acryloyloxy groups include trimethylolpropane tri(meth)acrylate; pentaerythritol tri(meth)acrylate; tris(2-hydroxyethyl)isocyanurate tri(meth)acrylate; ethoxylated trimethylolpropane tri(meth)acrylate; propoxylated trimethylolpropane tri(meth)acrylate; pentaerythritol tetra(meth)acrylate; dipentaerythritol penta(meth)acrylate; dipentaerythritol hexa(meth)acrylate; tripentaerythritol tetra(meth)acrylate; tripentaerythritol penta(meth)acrylate; tripentaerythritol hexa(meth)acrylate; tripentaerythritol hepta(meth)acrylate; tripentaerythritol octa(meth)acrylate;

a reaction product made from pentaerythritol tri(meth)acrylate and an acid anhydride; a reaction product made from dipentaerythritol penta(meth)acrylate and an acid anhydride; a reaction product made from tripentaerythritol hepta(meth)acrylate and an acid anhydride;

caprolactone modified trimethylolpropane tri(meth)acrylate; caprolactone modified pentaerythritol tri(meth)acrylate; caprolactone modified tris(2-hydroxyethyl)isocyanurate tri(meth)acrylate; caprolactone modified pentaerythritol tetra(meth)acrylate; caprolactone modified dipentaerythritol penta(meth)acrylate; caprolactone modified dipentaerythritol hexa(meth)acrylate; caprolactone modified tripentaerythritol tetra(meth)acrylate; caprolactone modified tripentaerythritol penta(meth)acrylate; caprolactone modified tripentaerythritol hexa(meth)acrylate; caprolactone modified tripentaerythritol hepta(meth)acrylate; caprolactone modified tripentaerythritol octa(meth)acrylate; a reaction product made from caprolactone modified pentaerythritol tri(meth)acrylate and an acid anhydride; a reaction product made from caprolactone modified dipentaerythritol penta(meth)acrylate and an acid anhydride; and a reaction product made from caprolactone modified tripentaerythritol hepta(meth)acrylate and an acid anhydride.

The term, “caprolactone modified” means that a ring-opened product from caprolactone or a ring-opened polymer is introduced into a moiety between an alcohol-originating moiety of a (meth)acrylate compound and an (meth)acryloyloxy group.

Examples of a commercially available product of polyfunctional acrylate include products A-DOD-N, A-HD-N, A-NOD-N, APG-100, APG-200, APG-400, A-GLY-9E, A-GLY-20E, A-TMM-3, A-TMPT, AD-TMP, ATM-35E, A-TMMT, A-9550, A-DPH, HD-N, NOD-N, NPG, and TMPT (manufactured by Shin-Nakamura Chemical Co., Ltd.); products ARONIXes “M-220”, “M-325”, “M-240”, “M-270”, “M-309”, “M-310”, “M-321”, “M-350”, “M-360”, “M-305”, “M-306”, “M-450”, “M-451”, “M-408”, “M-400”, “M-402”, “M-403”, “M-404”, “M-405”, and “M-406” (manufactured by Toagosei Co., Ltd.); and products EBECRYLs “11”, “145”, 150”, “40”, “140”, and “180”, and DPGDA, HDDA, TPGDA, HPNDA, PETIA, PETRA, TMPTA, TMPEOTA, DPHA, and EBECRYL series (manufactured by Daicel-Cytec Co., Ltd.).

The width of convexes in the groove orientation layer is preferably 0.05 to 5 μm, the width of concaves thereof is preferably 0.1 to 5 μm, and the depth of the level difference of the irregularities is preferably 2 μm or less, more preferably from 0.01 to 1 μm in order to achieve an orientation with small disturbance.

### <Method for Producing Laminate>

A method for producing a laminate including a liquid crystal cured layer, a pressure sensitive adhesive layer and a receiver is a method ofs forming a liquid crystal cured layer on a substrate, laminating the liquid crystal cured layer to a receiver through a pressure sensitive adhesive layer and then removing the substrate.

The pressure sensitive adhesive layer can be formed either on a liquid crystal cured layer or on a receiver. When an orientation layer exists between a substrate and a crystal liquid cured layer, the orientation layer can be also removed along with the substrate.

A substrate having a functional group chemically binding with a liquid crystal cured layer or an orientation layer on the surface, tend to be difficult to remove due to chemically binding with a liquid crystal cured layer or an orientation layer. Therefore, when the substrate is peeled to remove, a substrate having less functional groups on the surface is preferred and a substrate not surface-treating to forming a functional group at the surface is preferred.

The orientation layer having a functional group chemically binding with a substrate tends to have a larger adhesion force between the orientation layer and the substrate, and therefore, when the substrate is peeled to remove, an orientation layer having less functional groups chemically binding with a substrate is preferred. A solution of a orienting polymer composition or a composition for forming a photo-orientation layer is preferably not to contain a reagent to crosslink a substrate and an orientation layer, and furthermore preferably not to contain a component which dissolves the substrate.

The orientation layer having a functional group chemically binding with a liquid crystal cured layer tends to have a larger adhesion force between the orientation layer and the liquid crystal cured layer. Therefore, when the orientation layer is removed along with the substrate, the orientation layer having less functional groups chemically binding with the liquid crystal cured layer is preferred. A solution of the orienting polymer composition or the composition for forming a photo-orientation layer is preferably not to contain a reagent to crosslink the liquid crystal cured layer and the orientation layer.

The liquid crystal cured layer having a functional group chemically binding with a substrate or an orientation layer tends to have a larger adhesion force between either the substrate or the orientation layer and the liquid crystal cured layer. Therefore, when the substrate or the orientation layer is removed along with the substrate, the liquid crystal cured layer having less functional groups chemically binding with the substrate or the orientation layer is preferred. A composition for forming liquid crystal cured layer is preferably not to contain a reagent to crosslink the substrate or the orientation layer and the liquid crystal cured layer.

### <Pressure Sensitive Adhesive Layer>

A pressure sensitive adhesive layer is formed from a pressure sensitive adhesive. Examples of pressure sensitive adhesives include an adhesive, a drying curing type adhesive and chemical reactive adhesive. Examples of chemical reactive adhesives include an active energy ray-curing adhesive.

### <Adhesive>

An adhesive usually contains a polymer and also can contain a solvent.

Examples of polymers include acrylic polymer, silicone polymer, polyester, polyurethane or polyether. Among them, preferred is an acrylic adhesive containing the acrylic polymer since it has excellent optical transparency, appropriate wetting property and cohesion and excellent adhesion as well as high resistances to weather and heat and less lifting and peeling under heating or humidifying.

Acrylic polymer is preferred a copolymer of (meth)acrylate wherein an alkyl group of ester moiety is an alkyl group having 1 to 20 carbon atoms such as a methyl group, an ethyl group or a butyl group (hereinafter, acrylate and methacrylate are collectively sometimes referred to as (meth)acrylate, and acrylic acid and methacrylic acid are collectively sometimes referred to as (meth)acrylic acid) with a (meth)acrylic monomer having a functional group such as (meth)acrylic acid and hydroxyethyl(meth)acrylate.

An adhesive containing such copolymer is preferred since it is excellent in adhesiveness and adhesive residue is not left on the display device and the adhesive can be removed with comparative ease when it adheres to a display device and then is removed therefrom. The acrylic polymer preferably has a glass transition temperature of 25° C. or less, more preferably 0° C. or less. Such an acrylic polymer preferably has a weight-average molecular weight of 100000 or more.

Examples of solvents include solvents mentioned as solvents of the orienting polymer composition.

The adhesive can contain a light diffusing agent. The light diffusing agent is an agent imparting light diffusing property to an adhesive, and can be fine particles having a refractive index different from that of polymer contained in the adhesive. Examples of the light diffusing agent include fine particles composed of an inorganic compound and those composed of an organic compound (polymer). Most of polymers contained in an adhesive as active component, including an acrylic polymer, have about 1.4 of refractive index and therefore, the light diffusing agent having 1 to 2 of a refractive index can be selected, if applicable. Difference between refractive indexes of polymer contained in the adhesive as active component and of a light diffusing agent is usually 0.01 or more, preferably 0.01 to 0.5 in view of brightness and display performance of a display device. Fine particles used as a light diffusing agent are preferably in the spherical form, particularly nearly monodispersed form, and preferably have average particle diameter of 2 to 6 μm.

The refractive index is measured by ordinary minimum deviation methods or Abbe's refractometer.

Examples of fine particles composed of an inorganic compound include aluminum oxide (refractive index: 1.76) and silicon oxide (refractive index: 1.45).

Examples of fine particles composed of an organic compound (polymer) include melamine beads (refractive index: 1.57), polymethyl methacrylate beads (refractive index: 1.49), methyl methacrylate/stylene copolymer resin beads (refractive index: 1.50 to 1.59), polycarbonate beads (refractive index: 1.55), polyethylene beads (refractive index: 1.53), polystyrene beads (refractive index: 1.6), polyvinyl chloride beads (refractive index: 1.46), and silicone resin beads (refractive index: 1.46).

The content of light diffusing agent is usually 3 to 30 parts by mass relative to 100 parts by mass of polymer.

A pressure sensitive adhesive layer formed from adhesive in which the light diffusing agent is dispersed preferably has a haze value of 20 to 80% in view of ensuring brightness of a display device and reduction of bleeding or blurring display images. The haze value is a value represented by (Diffuse transmittance/total light transmittance)×100(%) and is measured according to JIS K 7105.

A thickness of the pressure sensitive adhesive layer formed from an adhesive which is determined depending on its adhesion and the like, is usually from 1 to 40 μm. The thickness is preferably 3 to 25 μm in view of processability and durability. When the pressure sensitive adhesive layer formed from an adhesive has a thickness of 3 to 15 μm, the display device can maintain lightening of view from the front or the sideways and reduce bleeding and blurring display images.

### <Drying Curing Adhesive>

A drying curing adhesive can contain a solvent.

Examples of drying curing adhesives include a polymer of a protonic functional group such as a hydroxyl group, a carboxy group or an amino group with a monomer having an ethylenically unsaturated group or a composition containing a urethane resin as main component, and a crosslinking agent or a curable compound such as polyaldehyde, epoxy compound, epoxy resin, melamine compound, zirconia compound and zinc compound.

Examples of polymers of a protonic functional group such as a hydroxyl group, a carboxy group or an amino group with a monomer having an ethylenically unsaturated group include an ethylene-maleic acid copolymer, an itaconic acid copolymer, an acrylic acid copolymer, an acrylamide copolymer, a saponified product of polyvinyl acetate, and polyvinyl alcohol resin.

Examples of polyvinyl alcohol resins include polyvinyl alcohol, partially saponified polyvinyl alcohol, completely saponified polyvinyl alcohol, carboxy group-modified polyvinyl alcohol, acetoacetyl group-modified polyvinyl alcohol, methylol group-modified polyvinyl alcohol, and amino group-modified polyvinyl alcohol. The content of polyvinyl alcohol resin in aqueous adhesive is usually 1 to 10 parts by mass, preferably 1 to 5 parts by mass relative to 100 parts by mass of water.

Examples of urethane resins include a polyester ionomer urethane resin. Herein, a polyester ionomer urethane resin is a urethane resin having a polyester backbone into which a small amount of ionic component (hydrophilic component) is introduced. Such an ionomer urethane resin is emulsified in water to form an emulsion in the absence of an emulsifier and therefore, can be used as an aqueous adhesive. When a polyester ionomer urethane resin is used, addition of a water-soluble epoxy compound as a crosslinking agent to the polyester ionomer urethane resin is effective.

Examples of epoxy resins include a polyamide epoxy resin obtained by reacting polyamidepolyamine with epichlorohydrin wherein the polyamidepolyamine is obtained by reacting polyalkylenepolyamine such as diethylenetriamine or triethylenetetramine with dicarboxylic acid such as adipic acid. Examples of commercially available products of such a polyamide epoxy resin include “Sumirez resin (registered trademark) 650” and “Sumirez resin 67 5” manufactured by SUMIKA CHEMTEX CO., LTD. and “WS-525” manufactured by JAPAN PMC CORPORATION. When an epoxy resin is added, it is usually added in an amount of 1 to 100 parts by mass, preferably 1 to 50 parts by mass relative to 100 parts by mass of polyvinyl alcohol resin.

A thickness of the pressure sensitive adhesive layer formed from drying curing adhesive is usually from 0.001 to 5 μm, preferably from 0.01 to 2 μm, more preferably from 1 μm or less. When the pressure sensitive adhesive layer formed from drying curing adhesive is too thick, the liquid crystal cured layer is likely to have poor appearance.

### <Active Energy Ray-Curing Adhesive>

An active energy ray-curing adhesive can contain a solvent.

The active energy ray-curing adhesive is an adhesive which is subjected to irradiation of active energy ray to be cured.

Examples of active energy ray-curing adhesives include a cation-polymerizable adhesive containing an epoxy compound and a cation-polymerization initiator, a radical polymerizable adhesive containing acrylic curable component and radical polymerizable initiator, an adhesive containing both of a cation-polymerizable curable component such as epoxy compound and a radical-polymerizable curable component such as acrylic compound, and also containing a cation-polymerization initiator and radical polymerization initiator, and an adhesive which is curable by irradiation with electron beams without including a polymerization initiator. Preferred is a radical polymerizable and active energy ray-curing adhesive containing an acrylic curable component and a radical polymerization initiator. It is preferably that a cation-polymerizable and active energy ray-curing adhesive including an epoxy compound and a cation-polymerization initiator which is usable with substantial no solvent.

Examples of epoxy compounds include an aromatic compound containing a hydroxyl group or a glycidyl etherified product of open chain compound, a glycidyl aminated product of amino group-containing compound, an epoxidized product of open chain compound having C—C double bond, and an alicyclic epoxy compound in which glycidyloxy group or eopxyethyl group is bound directly or through alkylene to saturated carbocyclic ring or an epoxy group is bound directly to saturated carbocyclic ring. These epoxy compounds can be used alone or in combination. Among them, an alicyclic epoxy compound is preferred due to excellent cation-polymerization.

Examples of commercially available products of epoxy compounds include “jER series” manufactured by Mitsubishi Chemical Corporation, “Epiclon (registered trademark)” manufactured by DIC Corporation, “EPOTOHTO (registered trademark)” manufactured by Tohto Kasei Co., Ltd., “ADEKA RESIN (registered trademark)” manufactured by ADEKA CORPORATION, “Denacol (registered trademark)” manufactured by Nagase ChemteX Corporation, “Dow Epoxy” manufactured by Dow Chemical Company, and “TEPIC (registered trademark)” manufactured by NISSAN CHEMICAL INDUSTRIES, LTD. Examples of alicyclic epoxy compounds include “CELLOXIDE” (registered trademark) series and “CYCLOMER” (registered trademark) manufactured by DAICEL CORPORATION, and “Cyracure (registered trademark) UVR” series manufactured by Dow Chemical Company.

The active energy ray-curing adhesive containing an epoxy compound can further contain the other compound than epoxy compound. Examples of the other compound than epoxy compound include an oxetane compound and an acrylic compound. Among them, preferred is the oxetane compound since the curing rate of cation-polymerization can be possibly facilitated.

Examples of oxetane compound include “Aron Oxetane (registered trademark)” series manufactured by TOAGOSEI CO., LTD., “ETERNACOLL (registered trademark)” series manufactured by UBE INDUSTRIES, LTD.

The active energy ray-curing adhesive containing an epoxy compound or an oxetane compound is preferably used under neat condition.

A cation-polymerization initiator is a compound which generates cation species under irradiation of active energy ray such as ultraviolet ray and examples thereof include onium salts such as aromatic diazonium salts, aromatic iodonium salts and aromatic sulfonium salts, and an iron-arene complex. These cation-polymerization initiators each can be used alone or in combination.

Examples of commercially available products of cation-polymerization initiator include “Kayarad (registered trademark)” series manufactured by Nippon Kayaku Co., Ltd., “Cyracure UVI” series manufactured by Dow Chemical Company, “CPI” series manufactured by San-Apro Ltd., “TAZ”, “BBI” and “DTS” manufactured by Midori Kagaku Co., Ltd, “Adeka optomer” series manufactured by ADEKA CORPORATION, and RHODORSIL (registered trademark) manufactured by Rhodia.

The content of cation-polymerization initiator is usually 0.5 to 20 parts by mass, preferably 1 to 15 parts by mass relative to 100 parts by mass of the active energy ray-curing adhesive.

Examples of acrylic curable components include (meth)acrylate and (meth)acrylic acid such as methyl(meth)acrylate and hydroxyethyl(meth)acrylate.

Examples of radical polymerization initiator include a hydrogen abstraction type light radical generator and a ring-opening type light radical generator.

Examples of hydrogen abstraction type light radical generators include a naphthalene derivative such as 1-methylnaphthalene, anthracenederivative, pyrenederivative, carbazole derivative, benzophenone derivative, thioxanthone derivative and coumarin derivative.

Examples of ring-opening type light radical generators include a benzoin ether derivative, arylalkyl ketones such as an acetophenone derivative, oxime ketones, acylphosphine oxides, S-Phenyl thiobenzoates, titanocens, and a polymerized derivative thereof.

Among ring-opening type light radical generators, preferred are acylphosphine oxides, particularly, trimethylbenzoyldiphenylphosphine oxide (Trade name, “DAROCURE TPO”; Ciba Japan K.K.), bis(2,6-dimethoxy-benzoyl)-(2,4,4-trimethyl-pentyl)-phosphine oxide (Trade name, “CGI 403”); Ciba Japan K.K.), or bis(2,4,6-trimethylbenzoyl)-2,4-dipentoxyphenylphosphine oxide (Trade name, “Irgacure819”; Ciba Japan K.K.).

The active energy ray-curing adhesive can contain a sensitizer.

The content of sensitizer is preferably 0.1 to 20 parts by mass relative to 100 parts by mass of the active energy ray-curing adhesive.

The active energy ray-curing adhesive can further include an ion trapping agent, an antioxidant, a chain transfer agent, a tackifier, a thermoplastic resin, a filler, a fluidity controlling agent, a plasticizer and an antifoaming agent.

The active energy ray, herein, is defined as an energy ray capable of generation of an active species from degradation of an active species-generating compound. Examples of the active energy ray include visible ray, ultraviolet ray, infrared ray, X-ray, α-ray, β-ray, γ-ray and electron ray, preferably ultraviolet ray and electron ray.

The acceleration voltage at irradiation of electron ray is usually 5 to 300 kV, preferably 10 to 250 kV. The dose is usually 5 to 100 kGy, preferably 10 to 75 kGy.

Irradiation of electron ray is usually carried out in inert gas, however, it can be carried out under condition in which the air present or some oxygen is introduced.

The irradiation intensity of ultraviolet ray is usually 10 to 5000 mW/cm². The irradiation intensity of ultraviolet ray is preferably the intensity of wavelength range effective in activation of cation polymerization initiator or radical polymerization initiator. At such intensities, one or several irradiations are preferably carried out so that the integral volume of light is 10 mJ/cm² or more, preferably 10 to 5,000 mJ/cm².

Examples of light sources of ultraviolet ray include a low pressure mercury lamp, a medium pressure mercury lamp, a high pressure mercury lamp, an ultra-high pressure mercury lamp, a xenon lamp, a halogen lamp, a carbonarc lamp, a tungsten lamp, a gallium lamp, an excimer laser, a LED light source emitting light at 380 to 440 nm of wavelength, a chemical lamp, a black-light lamp, a microwave excitation mercury lamp, and a metal halide lamp.

Examples of solvents include water; alcohols such as methanol, ethanol, isopropyl alcohol, 1-butanol, 2-butanol, sec-butyl alcohol, tert-butyl alcohol, ethylene glycol, propylene glycol, and butanediol;

saturated aliphatic ether compounds such as propyl ether, isopropyl ether, butyl ether, isobutyl ether, n-amyl ether, isoamyl ether, methyl butyl ether, methyl isobutyl ether, methyl n-amyl ether, methyl isoamyl ether, ethyl propyl ether, ethylisopropyl ether, ethyl butyl ether, ethylisobutyl ether, ethyl n-amyl ether, and ethylisoamyl ether;
unsaturated aliphatic ether compounds such as allyl ether, and ethyl allyl ether;
aromatic ether compounds such as anisole, phenetole, phenyl ether, benzyl ether;
cyclic ether compounds such as tetrahydrofuran, tetrahydropyran, dioxane;
ethylene glycol ether compounds such as ethylene glycolmonomethylether, ethylene glycolmonoethylether, ethylene glycolmonobutylether, diethylene glycolmonomethylether, diethylene glycolmonoethylether, diethylene glycolmonobutylether;
monocarboxylic acid compounds such as formic acid, acetic acid, acetic anhydride, acrylic acid, citric acid, propionic acid, butyric acid;
organic acid ester compounds such as butyl formate, amyl formate, propyl acetate, isopropyl acetate, butyl acetate, sec-butyl acetate, amyl acetate, isoamyl acetate, 2-ethylhexyl acetate, cyclohexyl acetate, butylcyclohexyl acetate, ethyl propionate, butyl propionate, amyl propionate, butyl butyrate, diethyl carbonate, diethyl oxalate, methyl lactate, ethyl lactate, butyl lactate, triethyl phosphate;
ketone compounds such as acetone, ethyl ketone, propyl ketone, butyl ketone, methyl isopropyl ketone, methyl isobutyl ketone, diisobutyl ketone, acetylacetone, diacetone alcohol, cyclohexanone, cyclopentanone, methylcyclohexanone, cycloheptanone;
dicarboxylic acid compounds such as succinic acid, glutaric acid, adipic acid, undecanedioic acid, pyruvic acid, citraconic acid; 1,4-dioxane, furfural, and N-methylpyrrolidone.

Among them, preferred are water and alcohol, more preferably alcohol having 1 to 4 carbon atoms, even more preferably at least one selected from the group consisting of methanol, ethanol, isopropyl alcohol, 1-butanol, 2-butanol, sec-butyl alcohol, tert-butyl alcohol, ethylene glycol, propylene glycol, and butanediol, still more preferably isopropyl alcohol and/or 1-butanol.

Water can be pure water or water containing impurities at the same degree as tap water.

A thickness of the pressure sensitive adhesive layer formed from the active energy ray-curing adhesive usually is 0.001 to 5 μm, preferably 0.01 μm or more, preferably 4 μm or less, more preferably 3 μm or less. When the pressure sensitive adhesive layer formed from the active energy ray-curing adhesive is too thick, the liquid crystal cured layer is likely to have poor appearance.

### <Receivers>

Examples of receivers include the same objects as the substrates described above, a polarizer, and polarizing plate.

### <Polarizer and Polarizing Plate>

A polarizer has a polarizing function. Examples of polarizers include a stretched film which adsorbs a dye having a absorption anisotropy or a film on which a dye having a absorption anisotropy is applied. Examples of dye having absorption anisotropy include dichroic dye.

The stretched film which adsorbs dye having absorption anisotropy is usually manufactured through the step of uniaxial stretching polyvinyl alcohol resin film, the step of staining the polyvinyl alcohol resin film with dichroic dye and adsorbing the dichroic dye, the step of treating the polyvinyl alcohol resin film adsorbed dichroic dye with aqueous boric acid solution, and then the step of washing the film with water after treatment with aqueous boric acid solution.

The polyvinyl alcohol resin is obtained by saponifying polyvinyl acetate resin. Examples of polyvinyl acetate resin include polyvinyl acetate which is a homopolymer of vinyl acetate, and copolymer of vinyl acetate with the other monomer copolymerizable with vinyl acetate. Examples of the other monomers copolymerizable with vinyl acetate include unsaturated carboxylic acids, olefins, vinyl ethers, unsaturated sulfonic acids, and acrylamides having an ammonium group.

The polyvinyl alcohol resin usually has a saponification degree of 85 to 100 mol %, preferably 98 mol % or more. The polyvinyl alcohol resin can have been modified, and polyvinyl formal and polyvinyl acetal modified with aldehydes can be also used. The polyvinyl alcohol resin usually has a polymerization degree of 1,000 to 10,000, preferably 1,500 to 5,000.

The original film of the polarizer is obtained by film forming these polyvinyl alcohol resin. The polyvinyl alcohol resin can be film formed by any known methods. The polyvinyl alcohol based original film preferably has a thickness of 10 to 150 μm.

The uniaxial stretching of the polyvinyl alcohol resin film can be carried out before, concurrently with or after staining with dichroic dye. When a uniaxial stretching is carried out after staining, the uniaxial stretching can be carried out either before or concurrently with treatment with boric acid. The uniaxial stretching can be carried out at several steps. The uniaxial stretching can be carried out such that it is carried out either between rolls with peripheral speed different from each other or by means of a heated roll. The uniaxial stretching can be either dry stretching wherein it is carried out in the air, or wetting stretching wherein it is carried out for polyvinyl alcohol resin film swelling with a solvent. The stretching rate is usually 3 to 8 times.

Staining of a polyvinyl alcohol resin film by dichroic dye is carried out by a method of dipping the polyvinyl alcohol resin film in aqueous solution containing dichroic dye. Examples of dichroic dyes include iodine and an organic dichroic dyes. Examples of the organic dichroic dyes include dichroic direct dyes composed of disazo-compound such as C.I. DIRECT RED 39 and dichroic direct dyes composed of trisazo- or tetrakisazo-compound. The polyvinyl alcohol resin film is preferably subjected to dipping in water before staining.

When the dichroic dye is iodine, generally adopted is a method of dipping and staining the polyvinyl alcohol resin film in aqueous solution containing iodine and potassium iodide. The content of iodine in the solution is usually 0.01 to 1 part by mass relative to 100 parts by mass of water. The content of potassium iodide in the solution is usually 0.5 to 20 parts by mass relative to 100 parts by mass of water. The temperature of the solution used in staining is usually 20 to 40° C. The duration of dipping in the solution (staining period) is usually 20 to 1,800 seconds.

When the dichroic dye is an organic dichroic dye, generally adopted is a method of dipping the polyvinyl alcohol resin film in aqueous solution containing water-soluble dichroic dye and staining the film. The content of organic dichroic dye in the solution is usually 1×10⁻⁴ to 10 parts by mass, preferably 1×10⁻³ to 1 part by mass, more preferably 1×10⁻³ to 1×10⁻² parts by mass relative to 100 parts by mass of water. This solution can contain inorganic salts such as sodium sulfate as staining aid. The temperature of the solution is usually 20 to 80° C. The duration of dipping in the solution (staining period) is usually 10 to 1,800 seconds.

The treatment with boric acid after staining with dichroic dye can be usually carried out by a method of dipping the stained polyvinyl alcohol resin film in an aqueous solution containing boric acid. The content of boric acid in the solution is usually 2 to 15 parts by mass, preferably 5 to 12 parts by mass relative to 100 parts by mass of water. When iodine is used as a dichroic dye, the solution containing boric acid preferably contains potassium iodide and the content of potassium iodide is usually 0.1 to 15 parts by mass, preferably 5 to 12 parts by mass relative to 100 parts by mass of water. The duration of dipping in the solution containing boric acid is usually 60 to 1,200 seconds, preferably 150 to 600 seconds, more preferably 200 to 400 seconds. The temperature for treatment with boric acid is usually 50° C. or more, preferably 50 to 85° C., still more preferably 60 to 80° C.

The polyvinyl alcohol resin film after treatment with boric acid is usually washed with water. The washing with water can be carried out by a method of dipping the polyvinyl alcohol resin film treated with boric acid in water. The temperature of water in washing is usually 5 to 40° C. The duration of dipping is usually 1 to 120 seconds.

Drying treatment is carried out after the washing with water and then a polarizer is obtained. The drying treatment can be carried out with a hot-air dryer or a far infrared radiation heater. The temperature in drying is usually 30 to 100° C., preferably 50 to 80° C. The duration of drying is usually 60 to 600 seconds, preferably 120 to 600 seconds. The polarizer has reduced water content to a degree to be used practically by drying. The water content is usually 5 to 20 weight %, preferably 8 to 15 weight %. When the water content is reduced below 5 weight %, the flexibility of the polarizer is lost so that the polarizer may be damaged or broken after drying. When the water content is increased above 20 weight %, the heat stability of the polarizer is potentially worsened.

The polarizer, obtained by uniaxially stretching, staining with dichroic dye, treating with boric acid, washing with water and drying the polyvinyl alcohol resin film, preferably has a thickness of 5 to 40 μm.

Examples of the film on which a dye having absorption anisotropy is applied include a film obtained by applying a composition containing a dichroic dye having liquid crystal property or a composition containing dichroic dye and polymerizable liquid crystal compound.

While the film on which a dye having absorption anisotropy is applied is preferably thinner, however, the film is likely to have decreased strength and poor processability when the film is too thin. The film usually has a thickness of 20 μm or less, preferably 5 an or less, more preferably 0.5 to 3 μm.

Specific examples of the film on which a dye having absorption anisotropy is applied include the film disclosed in JP-A-2012-33249.

A polarizing plate is obtained by laminating a transparent protection film on at least one surface of the polarizer through an adhesive. Preferred is the same transparent film as the substrate mentioned above as the transparent protection film.

### <Method for Producing Laminate>

Methods for applying a composition for forming liquid crystal cured layer on a substrate surface or a surface of an orientation layer formed on the substrate include the same method examples as the method for applying an orienting polymer composition on a substrate. The thickness of the composition for forming liquid crystal cured layer applied is determined in view of the thickness of the liquid crystal cured layer to obtained.

Subsequently, the solvent contained in the composition for forming liquid crystal cured layer is removed under the condition that a polymerizable liquid crystal compound is not polymerized, so that a dried coating of the composition for forming liquid crystal cured layer on a surface of the substrate or the orientation layer is formed. Examples of methods for removing a solvent include natural drying, ventilation drying, heat drying, and reduced-pressure drying.

The dried coating is, for example, heated to provide liquid crystal-orientation of the polymerizable liquid crystal compound contained in the dried coating, and then, the dried coating is irradiated with energy while the liquid crystal-orientation is retained to polymerize the polymerizable liquid crystal compound. When the composition for forming liquid crystal cured layer contains a polymerization initiator, energy is preferably applied under the condition that the polymerization initiator is activated. When the polymerization initiator is a photopolymerization initiator, energy is preferably light. Light emitted is selected depending on types of the polymerization initiator contained in the dried coating or types of the polymerizable liquid crystal compound (particularly, types of the polymerization group contained in the polymerizable liquid crystal compound) and the amount thereof, if applicable. Examples of such light include light selected from the group consisting of visible light, ultraviolet light and laser light, and active electron rays. Among them, ultraviolet light is preferred in that progress of polymerization is easily controlled and a device widely used in the art can be used as a device for polymerizing. Therefore, preferably, the polymerizable liquid crystal compound contained in the composition for forming liquid crystal cured layer and the polymerization initiator are selected so as to polymerize by ultraviolet light. When polymerization is carried out by ultraviolet light, the dried coating is preferably cooled with an appropriate cooling means to control the polymerization temperature. When the polymerizable liquid crystal compound is polymerized at lower temperature using such a cooling means, appropriate liquid crystal cured layer can be produced even in using a substrate with low resistance to heat.

Thus, a liquid crystal cured layer having liquid crystal-orientation is formed on a substrate or a surface of an orientation layer.

### <Primer Layers>

A primer layer can be provided between a liquid crystal cured layer and a pressure sensitive adhesive layer.

The primer layer usually contains a transparent resin and is formed from a solution of transparent resin. The primer layers can inhibit defects of the liquid crystal cured layer at the time of forming a pressure sensitive adhesive layer. The transparent resin is preferably excellent in coating property, transparency after forming a primer layer and adhesion.

The solvent of the transparent resin solution is selected depending on solubility of the transparent resin. Examples of solvents include water, aromatic hydrocarbon solvents such as benzene, toluene, and xylene; ketone solvents such as acetone, methyl ethyl ketone, methyl isobutyl ketone; ester solvents such as ethyl acetate, isobutyl acetate; chlorinated hydrocarbon solvents such as methylene chloride, trichloroethylene, chloroform; alcohol solvents such as ethanol, 1-propanol, 2-propanol, 1-butanol. When the transparent resin solution containing an organic solvent is used to form a primer layer, optical property of the liquid crystal cured layer may be affected and therefore water is preferred.

Examples of transparent resins include an epoxy resin. The epoxy resin can be either one package curable ones or two package curable ones. Particularly preferred is water-soluble epoxy resin. Examples of water-soluble epoxy resin include a polyamideepoxy resin obtained by reacting polyamidepolyamine with epichlorohydrin wherein the polyamidepolyamine is obtained by reacting polyalkylenepolyamine such as diethylenetriamine and triethylenetetramine with dicarboxylic acid such as adipic acid. Examples of commercially available polyamideepoxy resin include “Sumirez resin (registered trademark) 650(30)” and “Sumirez resin (registered trademark) 675” available from SUMIKA CHEMTEX CO., LTD.

When the transparent resin is a water-soluble epoxy resin, another water-soluble resin such as polyvinyl alcohol resin is preferably used in combination in order to further improve application properties. The polyvinyl alcohol resin can be a modified polyvinyl alcohol resin such as a partially saponified polyvinyl alcohol, a completely saponified polyvinyl alcohol, a carboxyl group-modified polyvinyl alcohol, an acetoacetyl group-modified polyvinyl alcohol, a methylol group-modified polyvinyl alcohol, and an amino group-modified polyvinyl alcohol. Examples of appropriate commercially available polyvinyl alcohol resin include an anionic group-containing polyvinyl alcohol, KL-318 (trade name) available from KURARAY CO., LTD.

When the primer layer is formed from solution containing water-soluble epoxy resin, the content of epoxy resin is preferably 0.2 to 1.5 parts by mass relative to 100 parts by mass of water. When the polyvinyl alcohol resin is added to the solution, the amount thereof is preferably 1 to 6 parts by mass relative to 100 parts by mass of water. The primer layer has preferably a thickness of 0.1 to 10 μm.

Methods for forming primer layers are not limited and various known coating methods such as direct gravure method, reverse gravure method, die coating, comma coating, and bar coating can be used.

A pressure sensitive adhesive layer is formed by applying the pressure sensitive adhesive onto the surface of a liquid crystal cured layer or a primer layer. When the pressure sensitive adhesive contains a solvent, the pressure sensitive adhesive layer is formed by applying the pressure sensitive adhesive onto the surface of the liquid crystal cured layer or the primer layer and removing the solvent. The pressure sensitive adhesive layer formed from the adhesive can be formed by a method of applying an adhesive onto the surface of the film subjected to release treatment and removing the solvent to form a pressure sensitive adhesive layer on the surface of the film subjected to release treatment and then laminating the film with the pressure sensitive adhesive layer to the surface of the liquid crystal cured layer or the primer layer such that the pressure sensitive adhesive layer side is bonded.

Adhesion between the liquid crystal cured layer or primer layer and the pressure sensitive adhesive layer can be further improved by corona treatment.

Examples of a method for applying an pressure sensitive adhesive include the same method as exemplified as a method for applying the orienting polymer composition to the substrate. Examples of methods for removing the solvent from the applied pressure sensitive adhesive include the same method as the method for removing the solvent from the orienting polymer composition.

### <Circularly Polarizing Plate>

When a receiver is a polarizer or polarizing plate and the liquid crystal cured layer which the polymerizable liquid crystal compound horizontally oriented to in-plane of the substrate is cured, a circularly polarizing plate which is laminated with a polarizer or a polarizing plate, first pressure sensitive adhesive layer, liquid crystal cured layer and second pressure sensitive adhesive layer in this order is obtained by forming a pressure sensitive adhesive layer on the liquid crystal cured layer of a laminate including the liquid crystal cured layer, the pressure sensitive adhesive layer, and the polarizer or polarizing plate.

By forming a pressure sensitive adhesive layer on the liquid crystal cured layer of a laminate including the liquid crystal cured layer, the orientation layer, the pressure sensitive adhesive layer, and the polarizer or polarizing plate, a circularly polarizing plate which is laminated with the polarizer or polarizing plate, first pressure sensitive adhesive layer, the orientation layer, the liquid crystal cured layer and second pressure sensitive adhesive layer in this order is obtained.

### <Application>

The liquid crystal cured layer and the circularly polarizing plate can be used in various display devices. The display device is a device having a display element, and includes alight emitter or an light emission system as a light emitting source. Examples of display devices include a liquid crystal display, an organic electroluminescence (EL) display, an inorganic electroluminescence (EL) display, a touch panel display, an electron emitting display (field emission display (FED), a surface-conduction electron-emitter display (SED)), an electronic paper (display including an electronic ink and an electrophoresis element, a plasma display, a projection type display (grating light valve (GLV) display, a display having a digital micromirror device (DMD)) and a piezoelectric ceramic display. Liquid crystal display devices include any of a transmissive liquid crystal display, a semi-transmissive liquid crystal display, a reflective liquid crystal display, a direct viewing liquid crystal display and a projection type liquid crystal display device. The display device may be a display device which displays two dimensional images or a stereoscopic display device which displays three dimensional images. In particular, a circularly polarizing plate can be effectively used in an organic electroluminescence (EL) display device and an inorganic electroluminescence (EL) display device, and an optical compensation polarizing plate can be effectively used in a liquid crystal display device and a touch panel display device.

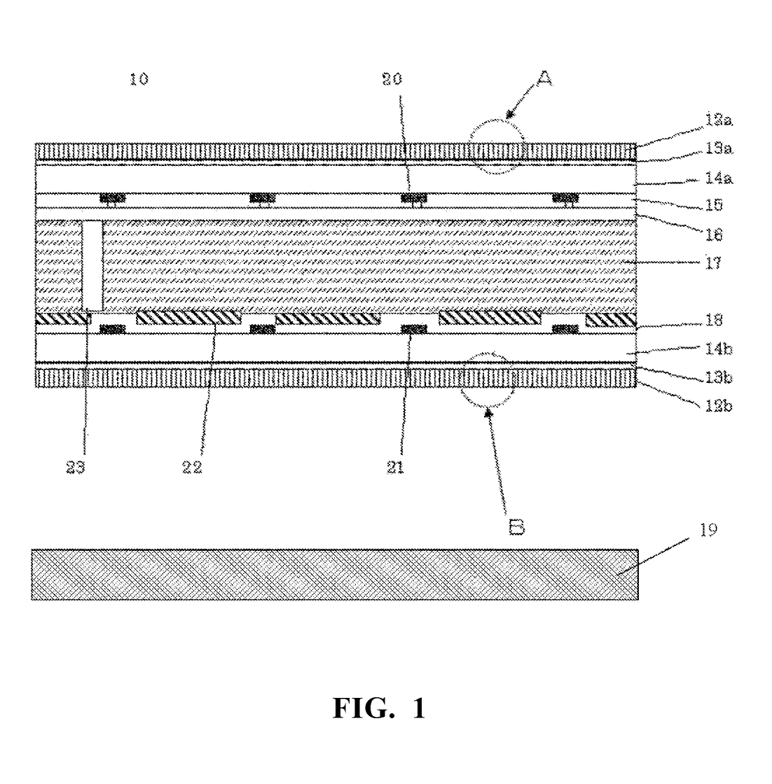

FIG. 1 is a schematic view showing cross sectional configuration of a liquid crystal display device 10 including liquid crystal cured layer. A liquid crystal layer 17 is sandwiched between two sheets of substrates 14a and 14b.

A color filter 15 is disposed at the side of liquid crystal layer 17 of the substrate 14a. The color filter 15 is disposed opposed to a pixel electrode 22 which sandwiches the liquid crystal layer 17, and a black matrix 20 is disposed at the position opposed to interfaces between the pixel electrodes. A transparent electrode 16 is disposed at the side of the liquid crystal layer 17 so as to cover the color filter 15 and the black matrix 20. It is noted that an overcoat layer (not shown) may be disposed between the color filter 15 and the transparent electrode 16.

At the side of the liquid crystal layer 17 of the substrate 14b, a thin film transistor 21 and the pixel electrode 22 are disposed with regularity. The pixel electrode 22 is disposed at the position opposed to the color filter 15 which sandwiches the liquid crystal layer 17. An interlayer insulation film 18 having a connecting hole (not shown) is disposed between the thin film transistor 21 and the pixel electrode 22.

A glass substrate and a plastic substrate is used as the substrate 14a and the substrate 14b. Examples of such a glass substrate and a plastic substrate include the same one as exemplified as the substrate described above. At the time of producing the color filter 15 and thin film transistor 21 formed on the substrate, when the step of heating at high temperature is required, a glass substrate and quartz substrate are preferred.

The thin film transistor can be optimally adopted depending on a material of the substrate 14b. Examples of the thin film transistor 21 include a high temperature polysilicon transistor formed on a quartz substrates, a low temperature polysilicon transistor formed on a glass substrate, an amorphous silicon transistor formed on a glass substrate or a plastic substrate. In order to compact a liquid crystal display device, a driver IC can be formed on the substrate 14b.

The liquid crystal layer 17 is disposed between the transparent electrode 16 and the pixel electrode 22. In the liquid crystal layer 17, a spacer 23 is disposed in order to keep a certain distance between the substrates 14a and 14b. It is noted that columnar spacers are illustrated, however, the spacer is not limited to the columnar shape and the shape is of any forms as long as the certain distance can be kept between substrates 14a and 14b.

Members are laminated in order of the substrate 14a, the color filter 15 and the black matrix 20, the transparent electrode 16, the liquid crystal layer 17, the pixel electrode 22, the interlayer insulating film 18, the thin film transistor 21, and the substrate 14b.

On the substrates 14a and 14b which sandwich the liquid crystal layer 17, the polarizing films 12a and 12b are provided at the outer side of the substrates 14a and 14b. Furthermore, retardation films (e.g. ¼ wavelength plate and optical compensation film) 13a and 13b are laminated, and among them, the liquid crystal cured layer of the present invention is used as at least one retardation film. The retardation film can impart a function to convert incident light to linearly polarized light to the liquid crystal display device 10. It is noted that the retardation films 13a and 13b do not need to be disposed depending on the configuration of the liquid crystal display device and types of the liquid crystal compound contained in liquid crystal layer 17.

The use of a liquid crystal cured layer for the retardation films 13a and/or 13b allows the liquid crystal display device 10 to be further in thinner form.

At outer side of the polarizing film 12b, a back light unit 19, a light emitting source, is disposed. The back light unit 19 includes a light source, a light guide body, a reflective plate, a diffusion sheet and a viewing angle adjusting sheet. Examples of light source include an electroluminescence, a cold cathode tube, a hot cathode tube, a light emitting diode (LED), laser light source and mercury lamp.

When the liquid crystal display device 10 is the transmissive liquid crystal display device, white light emitted from light source in the back light unit 19 is injected to the light guide body, and diffused with the diffusion sheet while changing the course by the reflective plate. The diffused light is adjusted with the viewing angle adjustment sheet to have desired directivity and then the light is injected from the back light unit 19 to the polarizing film 12b.

Among incident lights as being unpolarized light, one of linearly polarized light only transmits the polarizing film 12b of a liquid crystal panel. The linearly polarized light penetrates the substrate 14b, the pixel electrode 22, etc. in this order, and reaches the liquid crystal layer 17.

Herein, the presence or absence of potential difference between the pixel electrode 22 and the transparent electrode 16 opposed to the pixel electrode leads to changes of orientation states of liquid crystal molecules contained in the liquid crystal layer 17 whereby the brightness of light emitted from the liquid crystal display device 10 is controlled. When the liquid crystal layer 17 has an orientation in which polarized light directly transmits, light transmitted through the liquid crystal layer 17, the transparent electrode 16 and the color filter 15 is absorbed in the polarizing film 12a. Consequently, this pixel represents black.

Conversely, when the liquid crystal layer 17 has an orientation in which polarized light transmits after conversion, the polarized light transmits the liquid crystal layer 17, and the transparent electrode 16, and the polarized light, which falls within certain wavelength, transmits the color filter 15 and reaches the polarizing film 12a, so that the liquid crystal display device most brightly represents colors determined by the color filter. The intermediate orientation between these two states leads to the intermediate brightness of light emitted from the liquid crystal display device 10, resulting in that the pixel represents the intermediate colors.

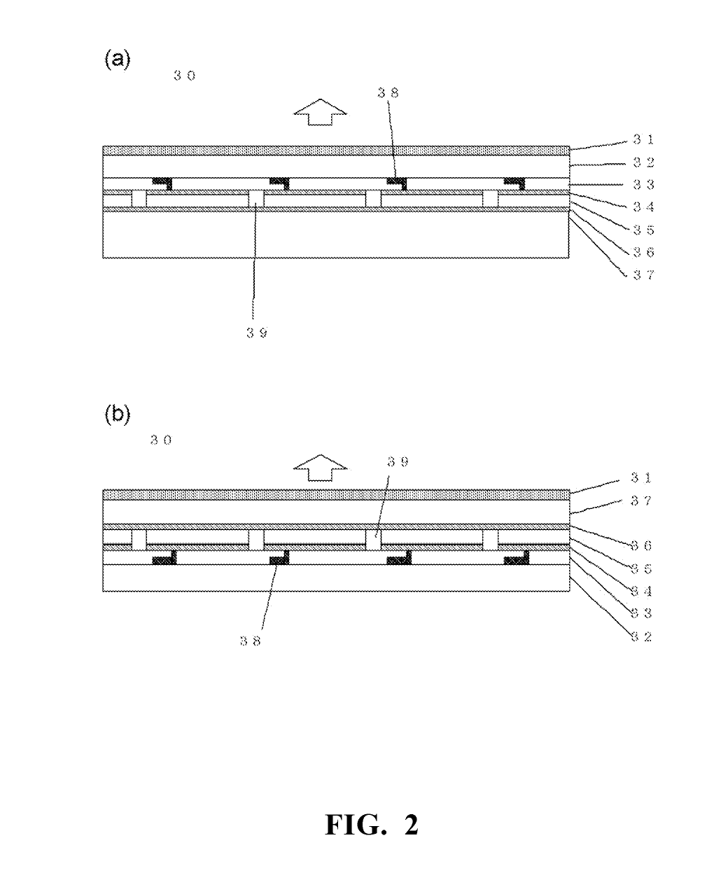

FIG. 2 is a schematic view showing an organic EL display device 30. The organic EL display device 30 illustrated in FIG. 2(a) includes a circularly polarizing plate 31, and has the structure wherein a luminescence layer 35 and a cathode electrode 36 are laminated on a substrate 32 on which a pixel electrode 34 is formed through an interlayer insulation film 33. The circularly polarizing plate 31 is disposed at opposite side to the luminescence layer 35 across the substrate 32. Voltages are positively applied on the pixel electrode 34 and negatively applied on the cathode electrode 36, respectively, and thereby direct current is applied between the pixel electrode 34 and the cathode electrode 36 to emit light from the luminescence layer 35. The luminescence layer 35 is composed of an electron transport layer, luminescence layer and a hole transport layer, etc. Light from the luminescence layer 35 passes through the pixel electrode 34, the interlayer insulation film 33, the substrate 32 and the circularly polarizing plate 31.

To manufacture the organic EL display device 30, a thin film transistor 38 is firstly formed on the substrate 32 in the desired form. Subsequently, the interlayer insulation film 33 is formed and then the pixel electrode 34 is film formed by sputtering to be patterned. Subsequently, the luminescence layer 35 is laminated thereon.

Then, the circularly polarizing plate 31 is provided on the opposite surface to the surface provided with the thin film transistor 38 of the substrate 32. In this case, the polarizing plate of the circularly polarizing plate 31 is disposed so as to be outside (the opposite side of the substrate 32).

Examples of the substrate 32 include a sapphire glass substrate, a quartz glass substrate, a ceramic substrate such as soda glass substrate and alumina, a metal substrate such as copper, a plastic substrate. A thermoconductive film, which is not shown, can be formed on the substrate 32. Examples of the thermoconductive film include a diamond thin film (DLC, etc.). When the pixel electrode 34 is of reflective type, light is emitted to the opposite side of the substrate 32. Accordingly, transparent materials as well as nontransparent materials such as stainless steel can be used. The substrate can be formed alone or substrates can be bonded with adhesive to forma laminated substrate. The substrate can be in a plate or film form.

Polycrystalline silicon transistor, etc. can be used as the thin film transistor 38. The thin film transistor 38 is provided at the end of the pixel electrode 34, and has a size of 10 to 30 μm. It is noted that the pixel electrode 34 has a size of 20 μm×20 μm to 300 μm×300 μm.

The wiring electrode of the thin film transistor 38 is provided on the substrate 32. The wiring electrode has a low resistance since it electrically contacts with the pixel electrode 34 to suppress resistance. Generally, the wiring electrode is used which contains any one or two or more of Al, Al and transition metal (excluding Ti), Ti or titanium nitride (TiN).

The interlayer insulation film 33 is provided between the thin film transistor 38 and the pixel electrode 34. The interlayer insulation film 33 can be any one in which inorganic materials such as silicon oxide such as SiO₂, and silicon nitride are film formed by sputtering or vacuum vapor deposition and which has coatings based on resin material such as silicon oxide layer formed by SOG (Spin On Glass), photoresist, polyimide and acrylic resin and insulation properties.

A rib 39 is formed on the interlayer insulation film 33. The rib 39 is disposed in the periphery of the pixel electrode 34 (between adjacent pixels). Materials of the rib 39 include an acrylic resin and a polyimide resin. The rib 39 preferably has a thickness of 1.0 to 3.5 μm, more preferably 1.5 to 2.5 μm.

Then, the EL element is described which is composed of the pixel electrode 34, the luminescence layer 35 and the cathode electrode 36. The luminescence layer 35 has at least one hole transport layer and luminescence layer, respectively, and has an electron-injection transfer layer, the luminescence layer, the hole transport layer and a hole injection layer, in this order.

Examples of the pixel electrode 34 include ITO (Indium Tin Oxide), IZO (Indium Zinc Oxide), IGZO, ZnO, SnO₂ and In₂O₃, and particularly preferred is ITO and IZO. The pixel electrode 34 preferably has a thickness, which is above certain and in which the hole injection is sufficiently carried out, of 10 to 500 nm.

The pixel electrode 34 can be formed by vapor deposition (preferably sputtering). Sputter gas includes inert gas such as Ar, He, Ne, Kr and Xe, or mixed gas thereof.

Examples of component materials of the cathode electrode 36 include metal elements such as K, Li, Na, Mg, La, Ce, Ca, Sr, Ba, Al, Ag, In, Sn, Zn and Zr, and in order to improve performance stability of electrode, preferred is the alloy system of 2 components or 3 components selected from the exemplified metal elements. The alloy system is preferably Ag.Mg (Ag: 1 to 20 at %), Al.Li (Li: 0.3 to 14 at %), In.Mg (Mg: 50 to 80 at %) and Al.Ca (Ca: 5 to 20 at %).

The cathode electrode 36 is formed by vapor deposition or sputtering method, etc. The thickness of the cathode electrode 36 is usually 0.1 nm or more, preferably 1 to 500 nm.

The hole injection layer has a function by which hole from the pixel electrode 34 is easily injected and the hole transfer layer has functions by which hole is transferred and electrons are prevented, respectively also referred to as charge injection layer and charge transport layer.

The luminescence layer, the combined layer of the hole injection layer and the hole transfer layer, and electron injection transfer layer each preferably has a thickness of 5 to 100 nm. Various types of organic compounds can be used as the hole injection layer and the hole transfer layer. In methods for forming the hole injection transfer layer, the luminescence layer and the electron injection transfer layer, preferred is vacuum vapor deposition method in that uniform thin film can be formed.

As the luminescence layer 35, for example, ones employing light emitted from singlet exciton (luminescence), ones employing light emitted from triplet exciton (phosphorescence), inclusion of ones employing light emitted from singlet exciton (luminescence) and ones employing light emitted from triplet exciton (phosphorescence), ones formed by organic matters, inclusion of ones formed by organic matters and ones formed by inorganic matters, polymer materials, low molecular materials and inclusion of polymer and low molecular materials can be used, and the luminescence layer 35 employing various known materials for EL element can be used in the organic EL display device 30.

A desiccant (not shown) is disposed in the space between the cathode electrode 36 and a sealing layer 37. The desiccant absorbs moisture to prevent the luminescence layer 35 from deterioration.

The organic EL display device 30 of the present invention, as shown in FIG. 2(b), includes the circularly polarizing plate 31, and has the structure wherein a luminescence layer 35 and a cathode electrode 36 are laminated on the substrate 32 on which the pixel electrode 34 is formed through the interlayer insulation film 33. The sealing layer 37 is formed on the cathode electrode and the circularly polarizing plate 31 is disposed at the opposite side to the substrate 32. Light emitted from the luminescence layer 35 passes through the cathode electrode 36, the sealing layer 37 and the circularly polarizing plate 31.

### EXAMPLES

The present invention is further described in reference to Examples. Terms “%” and “part” in Examples, are mass % and part by mass unless otherwise specified.

### [Preparation of Composition for Forming a Photo-Orientation Layer]

The following components were mixed and the resultant mixture was stirred at 80° C. for one hour to yield a composition for forming a photo-orientation layer (1). The following photo-orienting material was synthesized according to a method disclosed in JP-A-2013-33248.

Optically orienting material (1 part):

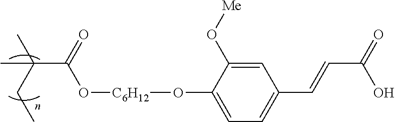

Solvent (99 parts): propyleneglycol monomethyl ether.

### [Preparation of Composition for Forming Liquid Crystal Cured Layer (1)]

The following components were mixed and the resultant mixture was stirred at 80° C. for one hour to yield a composition for forming liquid crystal cured layer (1):

Polymerizable liquid crystal compound A1 (86 parts):

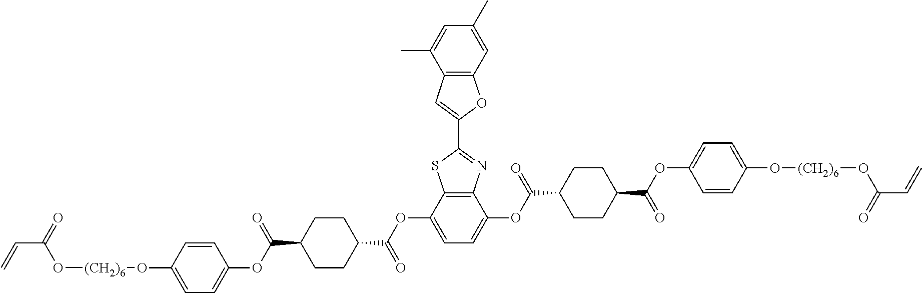

Polymerizable liquid crystal compound A2 (14 parts):

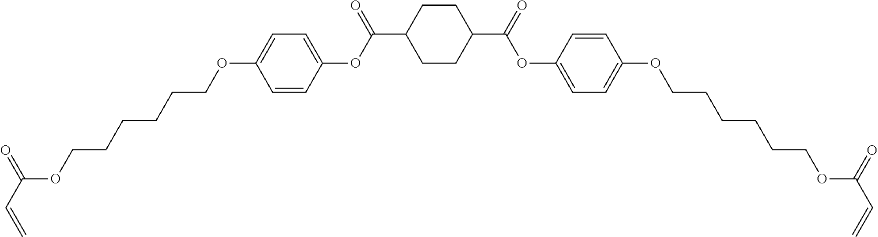 [SMILES: C=CC(=O)OCCCCCCOc1ccc(OC(=O)C2CCC(C(=O)Oc3ccc(OCCCCCCOC(=O)C=C)cc3)CC2)cc1]

Polymerization initiator (6 parts): 2-dimethylamino-2-benzyl-1-(4-morpholinophenyl) butane-1-one(IRGACURE 369; manufactured by BASF Japan Ltd.)

Leveling agent (0.1 parts): polyacrylate compound (BYK-361N; manufactured by BYK-Chemie)

Polymerization inhibitor (1 part): dibutylhydroxytoluene (manufactured by Wako Pure Chemical Industries, Ltd.)

Solvent: N-methyl-2-pyrrolidinone (160 parts), cyclopentanone (240 parts).

Polymerizable liquid crystal compound A1 was synthesized according to a method disclosed in JP-A-2010-31223.

Polymerizable liquid crystal compound A2 was synthesized according to a method disclosed in JP-A-2010-24438.

### [Preparation of Composition for Forming Liquid Crystal Cured Layer (2)]

A composition for forming liquid crystal cured layer (2) was yielded in the same manner as in preparation of composition for forming liquid crystal cured layer (1) except that polymerizable liquid crystal compound A2 of composition for forming liquid crystal cured layer (1) was replaced with polymerizable liquid crystal compound A3.

Polymerizable liquid crystal compound A3 (14 parts):

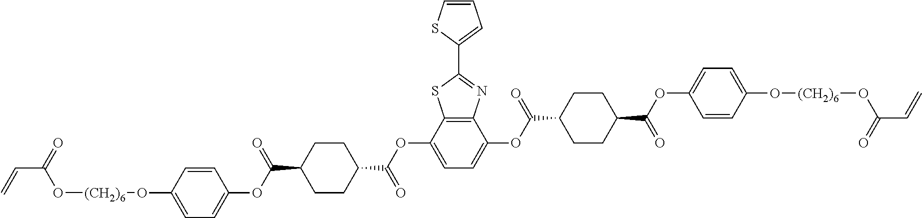

Polymerizable liquid crystal compound A3 was synthesized according to a method disclosed in JP-A-2010-31223.

### EXAMPLE

### Production of Liquid Crystal Cured Layer (1)

Onto polyethylene terephthalate film (PET) (Diafoil T140E25 manufactured by Mitsubishi Plastics, Inc.), a composition for forming a photo-orientation layer (1) was applied by a bar coater, and dried at 80° C. for one minute followed by subjecting to polarized UV light exposure at 100 mJ/cm² of accumulated light amount using a polarized UV light irradiation apparatus (SPOT CURE SP-7; manufactured by USHIO INC.). The thickness of the obtained photo-orientation layer was measured by a laser microscope (LEXT, manufactured by OLYMPUS CORPORATION) and the result was 90 nm.

Subsequently, onto the photo-orientation layer, a composition for forming liquid crystal cured layer (1) was applied by a bar coater and dried at 120° C. for one minute, followed by subjecting to irradiation with ultraviolet light (under a nitrogen atmosphere, wavelength: 365 nm, accumulated light amount at 365 nm of wavelength: 1000 mJ/cm²) using a high pressure mercury lamp (UNICURE VB-15201BY-A, manufactured by USHIO INC.) to form a liquid crystal cured layer (1).

### [Attenuated Total Reflection IR Spectroscopy]

Among surfaces vertical to the thickness direction of the obtained liquid crystal cured layer (1), the surface (surface A) of the opposite side to the photo-orientation layer side was measured using model 670-IR manufactured by Agilent (incident angle of 60°). The result is shown in Table 1.

An adhesive was bonded on the surface A, a COP film the surface of which was corona-treated was pressed and bonded with an adhesive and then, the PET film was removed to yield a laminate (1) having COP, pressure sensitive adhesive layer and liquid crystal cured layer (1), in this order. The other surface (surface B) of liquid crystal cured layer (1) also was measured (incident angle of 60°). The result is shown in Table 1.

### [Measurement of Retardation]

The thickness of liquid crystal cured layer (1) in laminate (1) was measured by a laser microscope (LEXT, manufactured by OLYMPUS CORPORATION). The retardation of liquid crystal cured layer (1) in laminate (1) was measured using KOBRA-WR manufactured by Oji Scientific Instruments. Note that the retardation value at 550 nm of wavelength of COP is substantially 0 and therefore, it does not affect the retardation value of liquid crystal cured layer (1). The result is shown in Table 2.

### [Transparency Evaluation]

Haze value of laminate (1) was measured by double beam method using haze meter (model HZ-2) manufactured by Suga Test Instruments Co., Ltd. As haze value is smaller, the transparency is more excellent. The result is shown in Table 2.

### Reference Example

Liquid crystal cured layer (2) and laminate (2) were obtained and evaluated in the same manner as in Example except that composition for forming liquid crystal cured layer (1) was replaced with composition for forming liquid crystal cured layer (2). The results are shown in Tables 1 and 2.

TABLE 1

| | | I(1) | I(2) | P | P1/P2 |
|---|---|---|---|---|---|
| Example | P1 | 0.0062 | 0.0507 | 0.12 | 0.63 |
| | P2 | 0.0099 | 0.0509 | 0.19 | |
| Reference | P1 | 0.0060 | 0.0473 | 0.13 | 0.55 |
| Example | P2 | 0.0110 | 0.0473 | 0.23 | |

P1: P value for one of surfaces vertical to a thickness direction of the liquid crystal cured layer,

P2: P value for the other of surfaces vertical to a thickness direction of the liquid crystal cured layer,

P value=I(1)/I(2),

I(1): Peak intensity from in-plane deformation vibration of ethylenically unsaturated bond obtained by attenuated total reflection IR spectroscopy (peak intensity at 1408 cm⁻¹), and

I(2): Peak intensity from stretching vibration of unsaturated bond of aromatic ring obtained by attenuated total reflection IR spectroscopy (peak intensity at 1504 cm⁻¹).

TABLE 2

| | Thickness | | | | Re(450)/ | Re(650)/ | Haze | |
|---|---|---|---|---|---|---|---|---|
| | (μm) | Re(450) | Re(550) | Re(650) | Re(550) | Re(550) | value (%) | Defects |
| Example | 2.1 | 118 | 136 | 140 | 0.87 | 1.03 | 0.53 | None |
| Reference | 2.2 | 116 | 132 | 134 | 0.88 | 1.02 | 1.96 | Streak |
| Example | | | | | | | | |

In the liquid crystal cured layer of Example, a transferring can be easily performed, resulting in reducing the occurrence of defects and exhibiting excellent transparency.

In the liquid crystal cured layer of the present invention, a transferring can be easily performed, resulting in reducing the occurrence of defects and exhibiting excellent transparency.

1. A liquid crystal cured layer formed from a polymerizable liquid crystal compound having an ethylenically unsaturated bond and an aromatic ring, the layer satisfying a formula (Y),
0.95>P1/P2>0.60 (Y)
wherein P1 is a value of P taken in one of two surfaces of the liquid crystal cured layer perpendicular to the thickness direction of the layer,
P2 is a value of P taken in the other surfaces,
wherein P is defined by
P=I(1)/I(2)
wherein I(1) is the intensity of a peak derived from in-plane deformation vibration of the ethylenically unsaturated bond measured by attenuated total reflection IR spectroscopy, and
I(2) is the intensity of a peak derived from stretching vibration of an unsaturated bond of the aromatic ring measured by attenuated total reflection IR spectroscopy.

2. The liquid crystal cured layer according to claim 1, the layer having a thickness of 0.5 to 5 μm.

3. The liquid crystal cured layer according to claim 1,
wherein the layer satisfies formulas (1) and (2):
Re(450)/Re(550)≦1.00 (1)
1.00≦Re(650)/Re(550) (2)
wherein Re(450), Re(550), and Re(650) represent front retardation values at wavelengths of 450 nm, 550 nm and 650 nm, respectively.

4. A method of producing a laminate comprising a steps of forming the liquid crystal cured layer according to claim 1 on a substrate, laminating the liquid crystal cured layer to a receiver via a pressure sensitive adhesive layer and removing the substrate.

5. A display device comprising the liquid crystal cured layer according to claim 1.

6. A display device comprising the liquid crystal cured layer according to claim 3.

7. The liquid crystal cured layer according to claim 2, wherein the layer satisfies formulas (1) and (2):
Re(450)/Re(550)≦1.00 (1)
1.00≦Re(650)/Re(550) (2)
wherein Re(450), Re(550), and Re(650) represent front retardation values at wavelengths of 450 nm, 550 nm and 650 nm, respectively.

8. A method of producing a laminate comprising a steps of forming the liquid crystal cured layer according to claim 2 on a substrate, laminating the liquid crystal cured layer to a receiver via a pressure sensitive adhesive layer and removing the substrate.

9. A method of producing a laminate comprising a steps of forming the liquid crystal cured layer according to claim 3 on a substrate, laminating the liquid crystal cured layer to a receiver via a pressure sensitive adhesive layer and removing the substrate.

10. A display device comprising the liquid crystal cured layer according to claim 2.
